(19) United States
(12) Patent Application Publication
(10) Pub. No.: US 2004/0077237 A1
(43) Pub. Date: Apr. 22, 2004

(54) Fluorochemical composition comprising perfluoropolyether and an extender for the treatment of fibrous substrates

(76) Inventors: Frans A. Audenaert, Kaprijke (BE); Rudolf J. Dams, Zwijndrecht (BE); Richard S. Buckanin, Woodbury, MN (US); Chetan P. Jariwala, Woodbury, MN (US); E. Steven McAlister, Woodbury, MN (US); Pierre J. Vander Elst, Elewijt (BE)

Correspondence Address: 3M INNOVATIVE PROPERTIES COMPANY, PO BOX 33427, ST. PAUL, MN, 55133-3427, US

(21) Appl. No.: 10/444,415

(22) Filed: May 23, 2003

Related U.S. Application Data
(60) Provisional application No. 60/383,085, filed on May 24, 2002.

(51) Int. Cl. D06M 10/00; B32B 5/02; B32B 27/04; B32B 27/12

(52) U.S. Cl. 442/82; 252/8.62

(57) ABSTRACT

A fluorochemical composition for rendering a fibrous substrate oil and/or water repellent without substantially adversely affecting the look and/or feel of the fibrous substrate, comprising a fluorinated polyether compound and an extender. The fluorinated polyether compound comprises one or more perfluorinated polyether groups and the extender comprises a non-fluorinated organic compound comprising one or more blocked isocyanate groups and/or a carbodiimide compound.

### CROSS REFERENCE TO RELATED APPLICATION

This application claims priority to U.S. Provisional Patent Application No. 60/383,085, filed May 24, 2002.

### FIELD OF THE INVENTION

The present invention relates to a fluorochemical composition for rendering fibrous substrates oil repellent, water repellent and/or stain repellent. In particular, the present invention relates to fluorochemical compositions that contain a fluorinated polyether compound and an extender. The invention further relates to a method of treating the fibrous substrate with the fluorochemical composition. The invention also relates to the use of a fluorochemical composition to render a fibrous substrate oil repellent, water repellent, and/or soil repellent.

### BACKGROUND

Compositions for making substrates, in particular fibrous substrates, such as textile, oil- and water repellent have been long known in the art. When treating fibrous substrates and in particular textile such as apparel, it is desired that the textile retains its look and feel as much as possible. Therefore, the composition should normally not contain components that would affect the look of the product, i.e., the treatment should be substantially invisible to the unaided human eye. Also the feel of the substrate should preferably be substantially unaffected. Typically this means that only low amounts of the solids of the composition can be applied. Accordingly, an oil- and/or water repellent composition should be highly effective in rendering a substrate repellent.

Commercially available oil- and/or water repellent compositions are typically based on fluorinated compounds that have a perfluorinated aliphatic group. Such compositions are also described in for example U.S. Pat. No. 5,276,175 and EP 435 641. The commercial success of this type of composition can be attributed to their high effectiveness. Fluorinated compounds based on perfluorinated ether moieties have also been described in the prior art for rendering fibrous substrates oil- and/or water repellent. For example, perfluorinated polyether compounds have been disclosed in EP 1 038 919, EP 273 449, JP-A-04-146917, JP-A-10-081873, U.S. Pat. No. 3,536,710, U.S. Pat. No. 3,814,741, U.S. Pat. No. 3,553,179 and U.S. Pat. No. 3,446,761. Unfortunately, it was found that prior art compositions based on perfluorinated polyether compounds may not be very effective in rendering a fibrous substrate oil- and/or water repellent compared to perfluoroaliphatic based compounds.

Accordingly, it is a desire to find fluorochemical compositions based on a perfluorinated polyether compound that can provide good to excellent oil- and/or water repellency properties to a fibrous substrate. Preferably, the fluorochemical composition is capable of providing durable oil- and/or water repellency properties to a fibrous substrate such that a treated fibrous substrate can substantially maintain the repellency properties even after several washing cycles. Preferably a fibrous substrate treated with the fluorochemical composition has a soft feel, preferably the feel of a treated fibrous substrate is either the same or softer compared to the untreated fibrous substrate. It is a further desire that the fluorochemical compositions can be easily and efficiently manufactured at a low cost. It is further desired to find compositions that have environmentally beneficial properties.

### SUMMARY OF THE INVENTION

In one aspect, the present invention provides a fluorochemical composition suitable for rendering a fibrous substrate oil and/or water repellent without substantially adversely affecting the look and/or feel of the fibrous substrate, comprising a fluorinated polyether compound and an extender. The fluorinated polyether compound comprises one or more perfluorinated polyether groups and the extender comprises a non-fluorinated organic compound comprising one or more blocked isocyanate groups and/or a carbodiimide compound.

It was surprisingly found that by adding the extender to the fluorinated polyether compound, fluorochemical compositions could be obtained that can provide much higher oil- and/or water repellency properties than the fluorinated polyether compound alone. The invention further offers the advantage that compositions can be obtained that are more environmentally friendly than many perfluoroaliphatic based compositions. Indications show that perfluorinated polyether compounds that have a perfluorinated polyether moiety having a molecular weight of at least 750 g/mol and perfluorinated polyether degradation products that may form therefrom eliminate well from the body of living organisms. In particular, there are indications that fluorinated polyether compounds having a fluorinated polyether moiety derivable from a polycondensation of hexafluoropropylene oxide and having a molecular weight of at least 750 g/mol would more effectively eliminate from the body of living organisms compared to long chain perfluoroaliphatic compounds.

Thus, in a preferred embodiment in connection with the present invention, the fluorinated compound is a compound that has one or more perfluorinated polyether moieties that have a molecular weight of at least 750 g/mol, in particular a perfluorinated polyether moiety derivable from hexafluoropropylene oxide.

In a further aspect, the invention relates to a fluorinated polyether compound obtainable by reacting a combination of reactants comprising:

(i) a fluorinated polyether of the formula:

R¹_{f}—O—[CF(CF₃)—CF₂O]ₙ—CF(CF₃)-A-Q¹-Tₖ

wherein R¹_{f} represents a perfluorinated alkyl group, n is an integer of 3 to 25, A is a carbonyl group or CH₂, Q¹ is a chemical bond or an organic divalent or trivalent linking group and T represents a functional group capable of reacting with an isocyanate, and k is 1 or 2;

(ii) a polyisocyanate compound or a mixture of polyisocyanate compounds, and

(iii) optionally one or more co-reactants capable of reacting with an isocyanate group.

The above fluorinated polyether compounds are particularly suitable for use in connection with this invention and are believed to be novel compounds.

In a still further aspect of the present invention, a fluorinated polyether compound is provided that comprises a non-fluorinated organic moiety having bonded to it a perfluorinated polyether group and a perfluoroaliphatic group having 3 to 18 carbon atoms, preferably having 3 to 5 or 6 carbon atoms. Such compounds may for example be represented by the formula:

(PFE)ᵤ—W—(PFA)_{w}

wherein PFE represents a perfluorinated polyether group, W represents a divalent or multivalent non-fluorinated organic linking group, PFA represents a perfluorinated aliphatic group having 3 to 18 carbon atoms, u and w each are at least 1. Compounds of this type have beneficial properties such as for example improved ability to disperse, dissolve or emulsify. Additionally, these compounds typically have good water- and/or oil-repellency properties, even without the presence of the extender in the composition.

Thus, in a still further aspect, the present invention also provides fluorochemical compositions based on fluorinated polyether compounds of the type referred to in the previous paragraph and which composition may or may not comprise an extender.

### DETAILED DESCRIPTION OF ILLUSTTRATIVE EMBODIMENTS OF THE INVENTION

Fluorinated Polyether Compound

The fluorinated polyether compound contained in the fluorochemical composition comprises one or more perfluorinated polyether moieties. By “perfluorinated polyether moiety” is meant the moiety of the fluorinated polyether compound that consists of carbon, fluorine and that contains at least two ether linkages without however including non-fluorinated end groups. Preferably, the molecular weight of the perfluorinated polyether moiety is at least 750 g/mol. A typical range for the molecular weight of the perfluorinated polyether moiety is between 750 g/mol and 5000 g/mol, preferably between 750 g/mol and 2500 g/mol. The perfluorinated polyether moiety may be a linear or branched chain. The fluorinated compound may contain one or more perfluorinated polyether moieties and these may have the same or different molecular weights and/or may differ in their structure. Also, the composition may contain a mixture of fluorinated compounds having perfluorinated polyether moieties of different structure and/or molecular weight. Preferably a major part or all of the perfluorinated polyether moieties of the fluorinated compound or mixture of fluorinated compounds have a molecular weight of at least 750 g/mol. Preferably not more than 10%, more preferably not more than 5% by weight and most preferably not more than 1% by weight of the perfluorinated polyether moieties in the fluorinated compound or mixture of fluorinated compounds have a molecular weight of less than 750 g/mol.

The fluorinated polyether compound may be a linear or branched perfluorinated polyether that optionally contains one or more acid groups, ester groups, hydroxy groups, thiol groups or amino groups at one or both ends of the perfluorinated polyether chain. Examples of such compounds include those represented by the formula:

Z¹-G¹-R_{f}(-G²-Z²)_{q}

wherein Z¹ and Z² each independently represents a functional group selected from an acid group, an ester group, an amido group, a hydroxy, a thiol or an amino group, G¹ and G² each independently represents a chemical bond or a non-fluorinated organic divalent linking group that may comprise an alkylene, carboxyalkylene and carbonamido alkylene, q is 0 or 1 and R_{f} is a divalent perfluoropolyether chain when q is 1 or a monovalent perfluoropolyether when q is 0.

Fluorinated polyether compounds according to the above formula include for example those disclosed in EP 1116759, EP 665 253, EP 870 778, EP 273 449 and EP 1 038 919. Specific examples include:

HOOC—CH₂—CF₂—O—(CF₂CF(CF₃)O)ₐ—CF₂—CH₂—COOH wherein a is an integer of 3 to 30;

HO—(CH₂)₃—CF₂—O—(CF₂CF(CF₃)O)ₐ—CF₂—(CH₂)₃—OH wherein a is an integer of 3 to 30;

HO—(CH₂)₂—CF₂—O—(C₂F₄O)_{c}—(CF₂O)_{d}—(CF(CF₃)CF₂O)_{w}—CF(CF₃)—(CH₂)₂—OH wherein at c, d and w are integers from 1 to 30 and wherein the sum of c, d and w is at least 3.

Alternatively, the fluorinated polyether compound may be a compound derived from the reaction of one or more perfluorinated polyethers having one or more functional groups and one or more non-fluorinated organic compounds having groups capable of reacting with the functional groups of the perfluorinated polyether compound. For example, the fluorinated compound may be obtained by reacting an amino- or hydroxy functionalised perfluorinated polyether, a polyisocyanate and optionally one or more coreactants such as an isocyanate blocking agent. Alternatively, the functional groups of the perfluorinated polyether compound may be a polymerizable group, e.g., an ethylenically unsaturated group, and the perfluorinated polyether compound can then be homopolymerized or copolymerized with non-fluorinated monomers and/or other fluorinated monomers.

Still further, the fluorinated polyether compound may comprise perfluoroaliphatic groups in addition to the perfluorinated polyether moieties. By “perfluoroaliphatic groups” is meant groups that consist of carbon and fluorine without however including perfluorinated end groups of the perfluorinated polyether moieties. Preferably, the perfluoroaliphatic group is a lower perfluoroaliphatic group of, for example, 3 to 5 or 6 carbon atoms, in particular a C₄F₉— group although long chain perfluoroaliphatic groups may also be present. However, long chain perfluoroaliphatic groups are not preferred. C₄F₉— based degradation products are expected to evacuate more quickly from living organisms than long chain perfluoroaliphatic groups. By including perfluoroaliphatic groups, in particular C₄F₉— groups in the fluorinated polyether compound, one can improve the solubility and/or dispersibility of the fluorinated polyether compound in the fluorochemical composition.

Such compounds include those that can be represented by the following formula:

(PFE)ᵤ—W—(PFA)_{w}

wherein PFE represents a perfluorinated polyether group, W represents a divalent or multivalent non-fluorinated organic linking group, PFA represents a perfluorinated aliphatic group having 3 to 18 carbon atoms, u and w each are at least 1. Preferably, as mentioned above, PFA will be a lower perfluoroaliphatic group. Compounds of the type above can be obtained by reacting a combination of reactants comprising of one or more perfluorinated polyethers having one or more isocyanate reactive functional groups, a polyisocyanate or polyisocyanate mixture, a perfluoroaliphatic compound having one or more isocyanate reactive groups and optionally one or more further co-reactants such as water or non-fluorinated organic compounds as described below. Such a reaction typically results in an organic linking group W that comprises urethane linkages. The compounds of the above type may also result from a copolymerization of a fluorinated polyether monomer having a perfluorinated ether group and a polymerizable group, fluorinated monomer having a perfluoroaliphatic group and a polymerizable group and optionally further co-monomers such as the non-fluorinated co-monomers described below. In this case, the linking group W will comprise a polymeric backbone.

The molecular weight of the fluorinated polyether compound can vary widely but will generally be selected such that fluorochemical compositions can be readily prepared therefrom by dissolving or dispersing the fluorinated polyether compound. Conveniently, the fluorinated polyether compound will have a molecular weight of not more than 300,000 and preferably not more than 100,000. Depending on the particular fluorinated polyether compound used, the molecular weight can be 50,000 or less and a typical range may be between 1500 g/mol and 5,000 g/mol or 10,000 g/mol. It will be understood that when the fluorinated polyether compound is comprised of a mixture of compounds, the above molecular weights refer to weight average molecular weights.

The perfluorinated polyether moieties of the fluorinated compound of the fluorochemical composition preferably correspond to the formula:

R¹_{f}—O—R_{f}²—(R_{f}³)_{q}— (I)

wherein R¹_{f} represents a perfluorinated alkyl group, R_{f}² represents a perfluorinated polyalkyleneoxy group consisting of perfluorinated alkyleneoxy groups having 1, 2, 3 or 4 carbon atoms or a mixture of such perfluorinated alkylene oxy groups, R³_{f} represents a perfluorinated alkylene group and q is 0 or 1. The perfluorinated alkyl group R¹_{f} in the above formula (I) may be linear or branched and may comprise 1 to 10 carbon atoms, preferably 1 to 6 carbon atoms. A typical perfluorinated alkyl group is CF₃—CF₂—CF₂—. R³_{f} is a linear or branched perfluorinated alkylene group that will typically have 1 to 6 carbon atoms. For example, R³_{f} is —CF₂— or —CF(CF₃)—. Examples of perfluoroalkylene oxy groups of perfluorinated polyalkyleneoxy group R²_{f} include:

—CF₂—CF₂—O—,

—CF(CF₃)—CF₂—O—,

—CF₂—CF(CF₃)—O—,

—CF₂—CF₂—CF₂—O—,

—CF₂—O—,

—CF(CF₃)—O—, and

—CF₂—CF₂—CF₂—CF₂—O.

The perfluoroalkyleneoxy group may be comprised of the same perfluoroalkylene oxy units or of a mixture of different perfluoroalkylene oxy units. When the perfluoroalkyleneoxy group is composed of different perfluoroalkylene oxy units, they can be present in a random configuration, alternating configuration or they can be present as blocks. Typical examples of perfluorinated polyalkylene oxy groups include: —[CF₂—CF₂—O]ᵣ—; —[CF(CF₃)—CF₂—O]ₙ—; —[CF₂CF₂—O]i—[CF₂O]ⱼ— and —[CF₂—CF₂—O]ₗ—[CF(CF₃)—CF₂—O]ₘ—; wherein r is an integer of 4 to 25, n is an integer of 3 to 25 and i, l, m, and j each are integers of 2 to 25. A preferred perfluorinated polyether group that corresponds to formula (I) is CF₃—CF₂—CF₂—O—[CF(CF₃)—CF₂O]ₙ—CF(CF₃)— wherein n is an integer of 3 to 25. This perfluorinated polyether group has a molecular weight of 783 when n equals 3 and can be derived from an oligomerization of hexafluoropropylene oxide. Such perfluorinated polyether groups are preferred in particular because of their benign environmental properties.

Examples of fluorinated compounds for use in the fluorochemical composition include compounds that correspond to the following formula (II):

R_{f}-Q-Tₖ (II)

wherein R_{f} represents a monovalent perfluorinated polyether group for example as described above, Q represents a chemical bond or a divalent or trivalent non-fluorinated organic linking group, T represents a functional group having a Zerewitinoff hydrogen atom and k is 1 or 2. Examples of linking groups Q include organic groups that comprise aromatic or aliphatic groups that may be interrupted by O, N or S and that may be substituted, alkylene groups, oxy groups, thio groups, urethane groups, carboxy groups, carbonyl groups, amido groups, oxyalkylene groups, thioalkylene groups, carboxyalkylene and/or an amidoalkylene groups. Examples of functional groups T include thiol, hydroxy and amino groups.

Commercially available compounds according to formula (II) include perfluoropolyether compounds available from Dupont under the tradename KRYTOX and under the tradename FLUORLINK and FOMBLIN from Ausimont. Still further examples of compounds according to above formula (II) are disclosed in EP 870 778.

In a particular embodiment, the fluorinated polyether corresponds to the following formula (IIa):

R_{f}¹—[CF(CF₃)—CF₂O]ₙ—CF(CF₃)-A-Q¹-Tₖ (IIa)

wherein R_{f}¹ represents a perfluorinated alkyl group e.g. having a linear or branched perfluorinated alkyl group having 1 to 6 carbon atoms, n is an integer of 3 to 25, A is a carbonyl group or CH₂, Q¹ is a chemical bond or an organic divalent or trivalent linking group for example as mentioned for the linking group Q above, k is 1 or 2 and T represents an isocyanate reactive group and each T may be the same or different. Particularly preferred compounds are those in which R¹_{f} represents CF₃CF₂CF₂—. In accordance with a particular embodiment, the moiety -A-Q¹-Tₖ is a moiety of the formula —CO—X—R^{a}(OH)ₖ wherein k is 1 or 2, X is O or NR^{b} with R^{b} representing hydrogen or an alkyl group of 1 to 4 carbon atoms, and R^{a} is an alkylene of 1 to 15 carbon atoms.

Representative examples of the moiety -A-Q¹-Tₖ in above formula (IIa) include:

1. —CONR^{c}—CH₂CHOHCH₂OH wherein R^{c} is hydrogen or an alkyl group of for example 1 to 4 carbon atoms;

2. —CONH-1,4-dihydroxyphenyl;

3. —CH₂OCH₂CHOHCH₂OH;

4. —COOCH₂CHOHCH₂OH; and

5. —CONR^{d}—(CH₂)ₘOH wherein R^{d} is hydrogen or an alkyl group such as methyl, ethyl, propyl, butyl, or hexyl and m is 2, 3, 4, 6, 8, 10 or 11.

Compounds according to formula (IIa) can for example be obtained by oligomerization of hexafluoropropylene oxide which results in a perfluoropolyether carbonyl fluoride. This carbonyl fluoride may be converted into an acid, ester or alcohol by reactions well known to those skilled in the art. The carbonyl fluoride or acid, ester or alcohol derived therefrom may then be reacted further to introduce the desired isocyanate reactive groups according to known procedures. For example, EP 870 778 describes suitable methods to obtained desired moieties -A-Q¹-Tₖ. Compounds having group 1 listed above can be obtained by reacting the methyl ester derivative of a fluorinated polyether with 3-amino-2-hydroxy-propanol. Compounds having the group 5 listed above can be obtained in a similar way by reacting with an amino-alcohol that has only one hydroxy function. For example 2-aminoethanol would yield a compound having the group 5 listed above with R^{d} being hydrogen and m being 2.

It will be evident to one skilled in the art that a mixture of fluorinated polyether compounds can be used. For example, such a mixture may comprise one or more compounds of formula (II), in particular of formula (IIa). In a preferred embodiment, such a mixture of fluorinated polyether compounds according to formula (II) or (IIa) is free of fluorinated polyether compounds having a perfluorinated polyether moiety having a molecular weight of less than 750 g/mol or alternatively the mixture contains fluorinated polyether compounds having a perfluorinated polyether moiety having a molecular weight of less than 750 g/mol in an amount of not more than 10% by weight relative to total weight of fluorinated polyether compounds, preferably not more than 5% by weight and most preferably not more than 1% by weight.

According to an alternative embodiment of the present invention, the fluorinated polyether compound comprises the reaction product of (i) one or more perfluorinated ether compounds according to the above formula (II) or (IIa), (ii) a polyisocyanate compound having two or more isocyanate groups or a mixture of polyisocyanate compounds and (iii) optionally one or more coreactants capable of reacting with an isocyanate group. Preferably, a polyisocyanate compound is used that has at least 3 isocyanate groups or alternatively a mixture of polyisocyanate compounds is used such that on average the mixture contains more than 2 isocyanate groups per molecule.

The polyisocyanate compound may be aliphatic or aromatic and is conveniently a non-fluorinated compound. Generally, the molecular weight of the polyisocyanate compound will be not more than 1500 g/mol. Examples include hexamethylenediisocyanate, 2,2,4-trimethyl-1,6-hexamethylenediisocyanate, and 1,2-ethylenediisocyanate, dicyclohexylmethane-4,4′-diisocyanate, aliphatic triisocyanates such as 1,3,6-hexamethylenetriisocyanate, cyclic trimer of hexamethylenediisocyanate and cyclic trimer of isophorone diisocyanate (isocyanurates); aromatic polyisocyanate such as 4,4′-methylenediphenylenediisocyanate, 4,6-di-(trifluoromethyl)-1,3-benzene diisocyanate, 2,4-toluenediisocyanate, 2,6-toluene diisocyanate, o, m, and p-xylylene diisocyanate, 4,4′-diisocyanatodiphenylether, 3,3′-dichloro-4,4′-diisocyanatodiphenylmethane, 4,5′-diphenyldiisocyanate, 4,4′-diisocyanatodibenzyl, 3,3′-dimethoxy-4,4′-diisocyanatodiphenyl, 3,3′-dimethyl-4,4′-diisocyanatodiphenyl, 2,2′-dichloro-5,5′-dimethoxy-4,4′-diisocyanato diphenyl, 1,3-diisocyanatobenzene, 1,2-naphthylene diisocyanate, 4-chloro-1,2-naphthylene diisocyanate, 1,3-naphthylene diisocyanate, and 1,8-dinitro-2,7-naphthylene diisocyanate and aromatic tri-isocyanates such as polymethylenepolyphenylisocyanate. Still further isocyanates that can be used for preparing the fluorinated compound include alicyclic diisocyanates such as 3-isocyanatomethyl-3,5,5-trimethylcyclohexylisocyanate; aromatic tri-isocyanates such as polymethylenepolyphenylisocyanate (PAPI); cyclic diisocyanates such as isophorone diisocyanate (IPDI). Also useful are isocyanates containing internal isocyanate-derived moieties such as biuret-containing tri-isocyanates such as that available from Bayer as DESMODUR™ N-100, isocyanurate-containing tri-isocyanates such as that available from Huls AG, Germany, as IPDI-1890, and azetedinedione-containing diisocyanates such as that available from Bayer as DESMODUR™ TT. Also, other di- or tri-isocyanates such as those available from Bayer as DESMODUR™ L and DESMODUR™ W, tri-(4 isocyanatophenyl)-methane (available from Bayer as DESMODUR™ R) and DDI 1410 (available from Henkel) are suitable.

The optional coreactant typically comprises water or a non-fluorinated organic compound having one or more Zerewitinoff hydrogen atoms. Examples include non-fluorinated organic compounds that have one, two or more functional groups that are capable of reacting with an isocyanate group. Such functional groups include hydroxy, amino and thiol groups. Examples of such organic compounds include aliphatic monofunctional alcohols, e.g., mono-alkanols having at least 1, preferably at least 6 carbon atoms, aliphatic monofunctional amines, a polyoxyalkylenes having 2, 3 or 4 carbon atoms in the oxyalkylene groups and having 1 or 2 groups having at least one Zerewitinoff hydrogen atom, polyols including diols such as polyether diols e.g. polytetramethylene glycol, polyester diols, dimer diols, fatty acid ester diols, polysiloxane diols and alkane diols such as ethylene glycol and polyamines.

Examples of monofunctional alcohols include methanol, ethanol, n-propyl alcohol, isopropyl alcohol, n-butyl alcohol, isobutyl alcohol, t-butyl alcohol, n-amyl alcohol, t-amyl alcohol, 2-ethylhexanol, glycidol and (iso)stearylalcohol.

Fatty ester diols are preferably diols that include an ester function derived from a fatty acid, preferably a fatty acid having at least 5 carbon atoms and more preferably at least 8 carbon atoms. Examples of fatty ester diols include glycerol mono-oleate, glycerol mono-stearate, glycerol mono-ricinoleate, glycerol mono-tallow, long chain alkyl di-esters of pentaerythritol having at least 5 carbon atoms in the alkyl group. Suitable fatty ester diols are commercially available under the brand RILANIT® from Henkel and examples include RILANIT® GMS, RILANIT® GMRO and RILANIT® HE.

Polysiloxane diols include polydialkylsiloxane diols and polyalkylarylsiloxane diols. The polymerization degree of the polysiloxane diol is preferably between 10 and 50 and more preferably between 10 and 30. Polysiloxane diols particularly include those that correspond to one of the following two formulas:

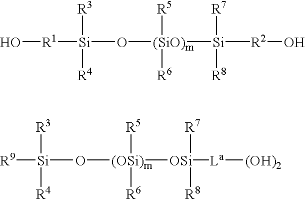

wherein R¹ and R² independently represent an alkylene having 1 to 4 carbon atoms, R³, R⁴, R⁵, R⁶, R⁷, R⁸ and R⁹ independently represent an alkyl group having 1 to 4 carbon atoms or an aryl group, L^{a} represents a trivalent linking group and m represents a value of 10 to 50. L^{a} is for example a linear or branched alkylene that may contain one or more catenary hetero atoms such as oxygen or nitrogen.

Further suitable diols include polyester diols. Examples include linear polyesters available under the brand UNIFLEX™ from Union Camp and polyesters derived from dimer acids or dimer diols. Dimer acids and dimer diols are well-known and are obtained by dimerisation of unsaturated acids or diols in particular of unsaturated long chain aliphatic acids or diols (e.g., at least 5 carbon atoms). Examples of polyesters obtainable from dimer acids and/or dimer diols are those available under the brand PRIPLAST from Uniqema.

Dimer diols include those that are commercially available from Uniqema under the brand PRIPOL™ which are believed to have been obtained from dimerisation of unsaturated diols in particular of unsaturated long chain aliphatic diols (e.g., at least 5 carbon atoms).

According to a particularly preferred embodiment, the organic compound will include one or more water solubilizing groups or groups capable of forming water solubilizing groups so as to obtain a fluorinated compound that can more easily be dispersed in water. Suitable water solubilizing groups include cationic, anionic and zwitter ionic groups as well as non-ionic water solubilizing groups. Examples of ionic water solubilizing groups include ammonium groups, phosphonium groups, sulfonium groups, carboxylates, sulfonates, phosphates, phosphonates or phosphinates. Examples of groups capable of forming a water solubilizing group in water include groups that have the potential of being protonated in water such as amino groups, in particular tertiary amino groups. Particularly preferred organic compounds are those organic compounds that have only one or two functional groups capable of reacting with NCO-group and that further include a non-ionic water-solubilizing group. Typical non-ionic water solubilizing groups include polyoxyalkylene groups. Preferred polyoxyalkylene groups include those having 1 to 4 carbon atoms such as polyoxyethylene, polyoxypropylene, polyoxytetramethylene and copolymers thereof such as polymers having both oxyethylene and oxypropylene units. The polyoxyalkylene containing organic compound may include one or two functional groups such as hydroxy or amino groups. Examples of polyoxyalkylene containing compounds include alkyl ethers of polyglycols such as e.g. methyl or ethyl ether of polyethyleneglycol, hydroxy terminated methyl or ethyl ether of a random or block copolymer of ethyleneoxide and propyleneoxide, amino terminated methyl or ethyl ether of polyethyleneoxide, polyethylene glycol, polypropylene glycol, a hydroxy terminated copolymer (including a block copolymer) of ethylene oxide and propylene oxide, a diamino terminated poly(alkylene oxide) such as Jeffamine™ ED, Jeffamine™ EDR-148 and poly(oxyalkylene)thiols.

Still further, the optional coreactant may include an isocyanate blocking agent. The isocyanate blocking agent can be used alone or in combination with one or more other coreactants described above. Isocyanate blocking agents are compounds that upon reaction with an isocyanate group yield a group that is unreactive at room temperature with compounds that at room temperature normally react with an isocyanate but which group at elevated temperature reacts with isocyanate reactive compounds. Generally, at elevated temperature the blocking group will be released from the blocked (poly)isocyanate compound thereby generating the isocyanate group again which can then react with an isocyanate reactive group. Blocking agents and their mechanisms have been described in detail in “Blocked isocyanates III.: Part. A, Mechanisms and chemistry” by Douglas Wicks and Zeno W. Wicks Jr., Progress in Organic Coatings, 36 (1999), pp. 14-172.

Preferred blocking agents include arylalcohols such as phenols, lactams such as ε-caprolactam, δ-valerolactam, γ-butyrolactam, oximes such as formaldoxime, acetaldoxime, cyclohexanone oxime, acetophenone oxime, benzophenone oxime, 2-butanone oxime or diethyl glyoxime. Further suitable blocking agents include bisulfite and triazoles.

In accordance with a particular embodiment, a perfluoroaliphatic group may be included in the fluorinated polyether compound and the co-reactant may then comprise a perfluoroaliphatic compound having one or more isocyanate reactive groups. The perfluoroaliphatic group contains 3 to 18 carbon atoms but preferably has 3 to 5 or 6 carbon atoms, in particular a C₄F₉— group. Preferred fluorinated co-reactants will correspond to the formula:

(R_{f}⁴)ₓ-L-Y (III)

wherein R_{f}⁴ represents a perfluoroaliphatic group having 3 to 5 or 6 carbon atoms, L represents a non-fluorinated organic divalent or multi-valent linking group such as for example organic groups that comprise alkylene, carboxy, sulfonamido, carbonamido, oxy, alkyleneoxy, thio, alkylenethio and/or arylene. Y represents a functional group having a Zerewitinoff hydrogen such as for example hydroxy, amino or thiol and x is an integer of 1 to 20, for example between 2 and 10. According to a particular embodiment, R_{f}⁴ is C₄F₉— and x is 1.

Compounds according to formula (III) in which x is 2 or more can be conveniently prepared through the polymerization of a perfluoroaliphatic compound having a polymerizable group in the presence of a functionalized chain transfer agent. Examples of such polymerizable perfluoroaliphatic compounds are those according to formula (VII) below and examples of suitable chain transfer include those according to formula (VIII) described further on below.

Specific examples of perfluoroaliphatic coreactants include:

C₄F₉—SO₂NR—CH₂CH₂OH,

C₄F₉—SO₂NR—CH₂CH₂—O—[CH₂CH₂O]ₜOH wherein n is 1 to 5,

C₄F₉SO₂NRCH₂CH₂CH₂NH₂,

C₄F₉—SO₂NR—CH₂CH₂SH,

C₄F₉—SO₂N—(CH₂CH₂OH)₂, and

C₄F₉—SO₂NR—CH₂CH₂O(CH₂)ₙOH wherein s is 2, 3, 4, 6, 8, 10 or 11;

wherein R is hydrogen or a lower alkyl of 1 to 4 carbons such as methyl, ethyl, and propyl.

The condensation reaction to prepare the above described fluorinated polyether compound can be carried out under conventional conditions well-known to those skilled in the art. Preferably the reaction is run in the presence of a catalyst. Suitable catalysts include tin salts such as dibutyltin dilaurate, stannous octanoate, stannous oleate, tin dibutyldi-(2-ethyl hexanoate), stannous chloride; and others known to those skilled in the art. The amount of catalyst present will depend on the particular reaction, and thus it is not practical to recite particular preferred concentrations. Generally, however, suitable catalyst concentrations are from about 0.001 percent to about 10 percent, preferably about 0.1 percent to about 5 percent, by weight based on the total weight of the reactants.

The condensation reaction is preferably carried out under dry conditions in a common organic solvent that does not contain Zerewitinoff hydrogens such as ethyl acetate, acetone, methyl isobutyl ketone, toluene and fluorinated solvents such hydrofluoroethers and trifluorotoluene. Suitable reaction temperatures will be easily determined by those skilled in the art based on the particular reagents, solvents, and catalysts being used. While it is not practical to enumerate particular temperatures suitable for all situations, generally suitable temperatures are between about room temperature and about 120° C.

Generally the reaction is carried out such that between 1 and 100% of the isocyanate groups of the polyisocyanate compound or mixture of polyisocyanate compounds is reacted with the perfluorinated polyether compound according to formula (II) above. Preferably between 5 and 60%, more preferably between 5 and 50% of the isocyanate groups are reacted with the perfluorinated polyether compound and the remainder are reacted with one or more coreactants as described above. An especially preferred fluorinated compound is obtained by reacting 10 to 30% of the isocyanate groups with the perfluorinated polyether compound according to formula (II), between 90 and 30% of the isocyanate groups with an isocyanate blocking agent and between 0 and 40% of the isocyanate groups with water, a fluorinated co-reactant as described above and/or a non-fluorinated organic compound other than an isocyanate blocking agent.

According to a still further embodiment in connection with the present invention, the fluorinated polyether compound is a fluorinated polymer that can be obtained by a polymerization of one or more fluorinated polyether monomers that comprise a perfluorinated polyether group preferably having a molecular weight of at least 750 g/mol and a polymerizable group, in particular a free radical polymerizable group such as an ethylenically unsaturated group. Typically, the fluorinated polyether monomer corresponds to the general formula:

PF-Q²-C(R)═CH₂ (IV)

wherein PF represents a perfluorinated polyether group preferably having a molecular weight of at least 750 g/mol e.g. a perfluorinated polyether group as described above, R is hydrogen or methyl and Q² is a non-fluorinated organic divalent linking group. Preferably Q² is a divalent linking group selected from the group consisting of:

*—CH₂-L¹-, *—COO-L²-, and *—CONR^{a}-L²-,

wherein L¹ represents a chemical bond or an organic divalent linking group, L² represents an organic divalent linking group and R^{a} is hydrogen or an alkyl group having 1 to 4 carbon atoms and * indicates the position where the linking group is attached to the group PF in formula (IV). Examples of organic divalent linking groups L¹ include an oxy group, an amido group, a carboxy group, a carbonyl group, an aryl group that may be substituted and an alkylene group that may be substituted and/or that may be interrupted with one or more heteroatoms or with an amido group, a carboxy group, a urethane group or a carbonyl group. Examples of divalent linking groups L² include an aryl group that may be substituted and an alkylene group that may be substituted and/or that may be interrupted with one or more heteroatoms or with an amido group, a carboxy group, a urethane group or a carbonyl group.

In a particular embodiment of the invention, the fluorinated polyether monomer corresponds to the formula:

R¹_{f}—O—[CF(CF₃)—CF₂O]ₙ—CF(CF₃)-Q²-C(R)═CH₂ (IVa)

wherein R¹_{f} represents a perfluorinated alkyl group, n is an integer of 3 to 25, R represents hydrogen or an alkyl group of 1 to 4 carbon atoms, Q² is a divalent linking group selected from the group consisting of:

*—CH₂-L¹- and *—COO-L²-,

wherein L¹ represents a chemical bond or an organic divalent linking group, L² represents an organic divalent linking group and * indicates the position where the linking group is attached to the perfluorinated polyether group.

Specific examples of compounds according to formula (IV) or (IVa) include:

A. PF—CONR—(CH₂)ₘO—COC(R′)═CH₂

wherein m is 2, 3, 4, 6, 8, 10, or 11; R is an alkyl group of 1 to 6 carbons; and R′ is H or methyl;

B. PF—COOCH₂CH(OH)CH₂O—COC(R′)═CH₂

wherein R′ is H or methyl;

C. PF—CONR—(CH₂)ₘO—CONHCH₂CH₂—OCO—C(R′)═CH₂

wherein m is 2, 3, 4, 6, 8, 10, 11; R is an alkyl group of 1 to 6 carbons; and R′ is H or methyl;

D. PF—CONR—(CH₂)ₘO—CONHCO—C(R′)═CH₂

wherein m is 2, 3, 4, 6, 8, 10, or 11; R is an alkyl group of 1 to 6 carbons; and R′ is H or methyl;

E. PF—CONR—(CH₂)ₘO—CONHC(Me)₂—C₆H₄—C(Me)=CH₂

wherein m is 2, 3, 4, 6, 8, 10, or 11; and R is an alkyl group of 1 to 6 carbons;

F. PF—CONR((CH₂)ᵣO)ₓ—COC(R′)═CH₂

wherein r is 2, 3 or 4; x is 1 to 10; R is an alkyl group of 1 to 6 carbons; and R′ is hydrogen or methyl.

In the above exemplified compounds, PF has the meaning as defined above and is preferably CF₃CF₂CF₂O—(CF(CF₃)CF₂O)ₙCF(CF₃)— with n being 3 to 25.

The fluorinated polyether compounds of the above formula (IV) and (IVa) can be readily obtained starting from, e.g., acid, ester or acid halide terminated perfluorinated polyether and reacting with an appropriate reactant to introduce the ethylenically unsaturated group and linking group Q². These reactions are well-known to those skilled in the art and examples of suitable reactions and reactants to introduce the ethylenically unsaturated group and linking group Q² can be found for example in EP 870 778. For example, the following table lists some -Q²-C(R)═CH₂ end groups that can be obtained from a reaction of an acid or ester terminated perfluorinated polyether with the indicated reactant:

| | Reactant |
|---|---|
| —CONHCH₂—CH═CH₂ | H₂NCH₂—CH═CH₂ |
| —CONH—C₆H₄—CH₂CH═CH₂ | H₂N—C₆H₄—CH₂CH═CH₂ |
| —COOCH₂CH═CH₂ | CH₂═CH—CH₂—OH |
| —CH₂OCH₂CH═CH₂ | 1) reduction with LiAlH₄ to CH₂OH |
| | 2) CH₂═CHCH₂Br |
| —CH₂OOC—C(CH₃)═CH₂ | 1) reduction with LiAlH₄ to CH₂OH |
| | 2) methacryloyl chloride |
| —CH₂OOCNH— | 1) reduction with LiAlH₄ to CH₂OH |
| CH₂CH₂—OOC—CH═CH₂ | 2) OCN—CH₂CH₂— |
| | OOC—CH═CH₂ |

Still further suitable fluorinated polyether monomers include those that correspond to the following general formula (V):

[PF-L³-X³—CONH]ₚ₋₁-Z-NHCOX⁴-L⁴-C(R^{b})═CH₂ (V)

wherein PF represents a perfluorinated polyether group preferably having a molecular weight of at least 750 g/mol, e.g., a perfluorinated polyether group as described above, L³ and L⁴ each independently represent a non-fluorinated organic divalent linking group, X³ and X⁴ independently represent O or NR^{a} wherein R^{a} is hydrogen or an alkyl group of 1 to 4 carbon atoms, Z represents a residue of a polyisocyanate having a valence p and wherein p is at least 2, and R^{b} represents hydrogen or methyl. Examples of non-fluorinated divalent linking groups L³ include alkylene, arylene, carboxy alkylene, carbonamido alkylene and oxyalkylene. Examples of linking groups L⁴ include alkylene, arylene, alkyleneoxy carbonyl, alkyleneoxy, alkyleneamido. A preferred linking group L³ is carboxyalkylene and a preferred linking group L⁴ is alkyleneoxy carbonyl. L³ and/or L⁴ may contain urethane or urylene linkages.

Fluorinated polyether monomers according to formula (V) can be obtained by first condensing a di- or triisocyanate, e.g., isocyanate compounds as described above, with, respectively, an equimolar or double molar amount of a perfluorinated polyether alcohol, thiol or amine of formula II. This reaction is typically carried out at temperatures between 50 and 80° C., by slow addition of the perfluorinated polyether alcohol, thiol or amine to a solution of the polyisocyanate in an anhydrous organic solvent without Zeriwittinof hydrogens, such as ethylacetate or isobutylmethylketone, further containing small amounts of radical inhibitors such as hydroquinone monoalkylethers or phenothiazine (50-200 ppm). Optionally a small amount of a tin or other suitable urethane catalyst can be added to accelerate the reaction. After completion of this first step an equimolar amount of a monofunctional polymerizable compound is added and reacted until all residual isocyanate groups have disappeared. For completion of the second step, sometimes additional catalyst and a slight excess of the polymerizable compound may be required. Preferred polymerizable compounds include acrylates, methacrylates, acrylamides or methacrylamides, that have been functionalized with a hydroxy, carboxyl, amino or thiol group. The condensation reaction may further involve a chain extender such as a diol or a diamine. Examples of chain extenders include alkane diols and alkane diamines.

Examples of fluorinated polyether monomers according to formula (V) include the following:

PF—CONR—(CH₂)ₘO—CONH—(CH₂)₆—NHCO(O(CH₂)ₚ)_{q}OCOC(R′)═CH₂

wherein m is 2, 3, 4, 6, 8, 10, or 1; p is 2, 3 or 4; q is 1-20; R is methyl, ethyl, propyl, butyl, or hexyl; and R′: H or methyl;

PF—CONR—(CH₂)ₘO—CONH—CH₂C(Me)₂CH₂CH(Me)CH₂CH₂NHCO(O(CH₂)ₚ)_{q}OCOC(R′)═CH₂

wherein m is 2, 3, 4, 6, 8, 10, or 11; p is 2, 3 or 4; q is 1-20; R is an alkyl group of 1 to 6 carbons; and R′ is H or Me;

PF—CONR—(CH₂)ₘO—CONHC₆H₁₀—CH₂—C₆H₁₀—NHCO(O(CH₂)ₚ)_{q}OCOC(R′)═CH₂

wherein m is 2, 3, 4, 6, 8, 10, or 11; p is 2, 3 or 4; q is 1-20; R is an alkyl group of 1 to 6 carbons; and R′ is H or Me;

PF—CONR—(CH₂)ₘO—CONH—C₆H₇—(CH₃)₃—CH₂—NHCO(O(CH₂)ₚ)_{q}OCOC(R′)═CH₂

wherein m is 2, 3, 4, 6, 8, 10, 11; p is 2, 3 or 4; q is 1-20; R is an alkyl group of 1 to 6 carbons; and R′ is H or Me;

PF—CONR—(CH₂)ₘO—CONH—C₆H₁₀—NHCO(O(CH₂)ₚ)_{q}OCOC(R′)═CH₂

wherein m is 2, 3, 4, 6, 8, 10, or 11; p is 2, 3 or 4; q is 1-20; R is an alkyl group of 1 to 6 carbons; and R′ is H or Me;

PF—CONR—(CH₂)ₘO—CONH—(CH₂)₆—NHCOCH₂CH₂OCOCH═CH₂

wherein m is 2, 3, 4, 6, 8, 10, or 11; and R is an alkyl group of 1 to 6 carbons;

PF—CONR—(CH₂)ₘO—CONH—(CH₂)₆—NHCOOCH₂NCOCR′═CH₂

wherein m is 2, 3, 4, 6, 8, 10, or 11; R is an alkyl group of 1 to 6 carbons; and R′ is H or Me; and

PF—CONR—(CH₂)ₘO—CONH—(CH₂)₆—NHCOOCH(CH₂Cl)CH₂OCOCR′═CH₂

wherein m is 2, 3, 4, 6, 8, 10, or 11; R is an alkyl group of 1 to 6 carbons; and R′ is H or Me.

In the above listed examples, PF has the meaning as defined above and is preferably CF₃CF₂CF₂O—(CF(CF₃)CF₂O)ₙCF(CF₃)— and Me represents methyl.

In one embodiment the fluorinated monomer is copolymerized with a non-fluorinated monomer to obtain the fluorinated polymer having perfluorinated polyether groups. Non-fluorinated monomers include for example a hydrocarbon group containing monomer such as monomers that can be represented by formula:

Rₕ-L^{b}-Z (VI)

wherein Rₕ represents an aliphatic group having 4 to 30 carbon atoms, L^{b} represents an organic divalent linking group and Z represents an ethylenically unsaturated group. The hydrocarbon group is preferably selected from the group consisting of a linear, branched or cyclic alkyl group, an aralkyl group, an alkylaryl group and an aryl group. Further non-fluorinated monomers include those wherein the hydrocarbon group in formula (VI) includes oxyalkylene groups or substituents, such as hydroxy groups and/or cure sites. The term cure sites includes functional groups that are capable of engaging in a reaction with the substrate to be treated. Examples of cure sites include acid groups such as carboxylic acid groups, hydroxy groups, amino groups and isocyanate groups or blocked isocyanate groups. A preferred cure site is a blocked isocyanate group or an isocyanate group.

Examples of non-fluorinated comonomers include hydrocarbon esters of an α,β-ethylenically unsaturated carboxylic acid. Examples include n-butyl(meth)acrylate, isobutyl(meth)acrylate, octadecyl(meth)acrylate, lauryl(meth)acrylate, cyclohexyl (meth)acrylate, cyclodecyl (meth)acrylate, isobornyl(meth)acrylate, phenyl (meth)acrylate, benzyl(meth)acrylate, adamantyl(meth)acrylate, tolyl(meth)acrylate, 3,3-dimethylbutyl(meth)acrylate, (2,2-dimethyl-1-methyl)propyl(meth)acrylate, cyclopentyl (meth)acrylate, 2-ethylhexyl(meth)acrylate, t-butyl(meth)acrylate, cetyl(meth)acrylate, stearyl(meth)acrylate, behenyl(meth)acrylate, isooctyl(meth)acrylate, n-octyl (meth)acrylate, 4-ethyl-cyclohexyl(meth)acrylate, 2-ethoxyethyl methacrylate and tetrahydropyranyl acrylate. Further non-fluorinated comonomers include allyl esters such as allyl acetate and allyl heptanoate; alkyl vinyl ethers or alkyl allyl ethers such as cetyl vinyl ether, dodecylvinyl ether, ethylvinyl ether; unsaturated acids such as acrylic acid, methacrylic acid, alpha-chloro acrylic acid, crotonic acid, maleic acid, fumaric acid, itaconic acid and their anhydrides and their esters such as vinyl, allyl, methyl, butyl, isobutyl, hexyl, heptyl, 2-ethylhexyl, cyclohexyl, lauryl, stearyl, isobornyl or alkoxy ethyl acrylates and methacrylates; alpha-beta unsaturated nitrites such as acrylonitrile, methacrylonitrile, 2-chloroacrylonitrile, 2-cyanoethyl acrylate, alkyl cyanoacrylates; alpha,beta-unsaturated carboxylic acid derivatives such as allyl alcohol, allyl glycolate, acrylamide, methacrylamide, n-diisopropyl acrylamide, diacetoneacrylamide, aminoalkyl (meth)acrylates such as N,N-diethylaminoethylmethacrylate, N-t-butylaminoethylmethacrylate; alkyl(meth)acrylates having an ammonium group such as (meth)acrylates of the formula X⁻R₃N⁺—R^{e}—OC(O)—CR^{f}═CH₂ wherein X⁻ represents an anion such as e.g. a chloride anion, R represents hydrogen or an alkyl group and each R may the same of different, R^{e} represents an alkylene and R^{f} represents hydrogen or methyl; styrene and its derivatives such as vinyltoluene, alpha-methylstyrene, alpha-cyanomethyl styrene; lower olefinic hydrocarbons which can contain halogen such as ethylene, propylene, isobutene, 3-chloro-1-isobutene, butadiene, isoprene, chloro and dichlorobutadiene and 2,5-dimethyl-1,5-hexadiene, hydrocarbon monomers comprising (poly)oxyalkylene groups including (meth)acrylates of a polyethylene glycol, (meth)acrylates of a block copolymer of ethylene oxide and propylene oxide, (meth)acrylates of amino- or diamino terminated polyethers and (meth)acrylates of methoxypolyethyleneglycols and hydrocarbon monomers comprising a hydroxyl group include hydroxylgroup containing (meth)acrylates, such as hydroxyethyl(meth)acrylate and hydroxypropyl(meth)acrylate. Preferably, the non-fluorinated comonomer(s) will comprise one or more chlorine containing monomers such as vinyl chloride and vinylidene chloride.

In a particular embodiment of the invention, the fluorinated polymer includes units having one or more cure sites. These units will typically derive from corresponding comonomers that include one or more cure sites. Examples of comonomers from which a cure site unit may derive include (meth)acrylic acid, maleic acid, maleic anhydride, allyl methacrylate, hydroxybutyl vinyl ether, N-hydroxymethyl(meth)acrylamide, N-methoxymethyl acrylamide, N-butoxymethyl acrylamide, N-isobutoxymethyl acrylamide, glycidylmethacrylate and α,α dimethyl benzyl meta-isopropenyl isocyanate. Other examples include polymerizable urethanes, that can be obtained by the reaction of a polymerizable mono-isocyanate with an isocyanate blocking agent or by the reaction of a di- or poly-isocyanate and a hydroxy or amino-functionalized acrylate or methacrylate and an isocyanate blocking agent for example as described above.

In a further embodiment, the fluorinated polymer may be obtained from a copolymerization of one or more fluorinated polyether monomers as described above, one or more fluorinated monomers having a polymerizable group and a perfluoroaliphatic group having 3 to 18 carbon atoms, preferably 3 to 5 or 6 carbon atoms and most preferably 4 carbon atoms as in C₄F₉—, and optionally one or more non-fluorinated monomers as described above.

Preferred fluorinated co-monomers that may be used in preparing the fluorinated polymer of the fluorochemical composition include those of the following formula:

R_{f}⁴-Q³-C(R^{e})═CH₂ (VII)

wherein R_{f}⁴ is a perfluoroaliphatic group of 3 to 5 or 6 carbon atoms, preferably C₄F₉—, R^{e} is hydrogen or a lower alkyl of 1 to 4 carbon atoms and Q³ represents a non-fluorinated organic divalent linking group. The linking group Q³ links the perfluoroaliphatic group to the free radical polymerizable group. Linking group Q³ is generally non-fluorinated and preferably contains from 1 to about 20 carbon atoms. Q³ can optionally contain oxygen, nitrogen, or sulfur-containing groups or a combination thereof, and Q³ is free of functional groups that substantially interfere with free-radical polymerization (e.g., polymerizable olefinic double bonds, thiols, and other such functionality known to those skilled in the art). Examples of suitable linking groups Q³ include straight chain, branched chain or cyclic alkylene, arylene, aralkylene, sulfonyl, sulfoxy, sulfonamido, carbonamido, carbonyloxy, urethanylene, ureylene, and combinations thereof such as sulfonamidoalkylene.

Specific examples of fluorinated aliphatic group containing monomers include:

CF₃CF₂CF₂CF₂CH₂CH₂OCOCR^{d}═CH₂,

CF₃(CF₂)₃CH₂OCOCR^{d}═CH₂,

CF₃(CF₂)₃SO₂N(CH₃)CH₂CH₂OCOCR^{d}═CH₂,

CF₃(CF₂)₃SO₂N(C₂H₅)CH₂CH₂OCOCR^{d}═CH₂,

CF₃(CF₂)₃SO₂N(CH₃)CH₂CH(CH₃)OCOCR^{d}═CH₂,

(CF₃)₂CFCF₂SO₂N(CH₃)CH₂CH₂OCOCR^{d}═CH₂, and

C₆F₁₃C₂H₄OOC—CR^{d}═CH₂

wherein R^{d} is hydrogen or methyl.

The fluorinated polymer may be a homopolymer or a copolymer that typically comprises between 5 and 95% by weight of units deriving from the fluorinated polyether monomer and between 95 and 5% by weight of units deriving from a non-fluorinated monomer and/or fluorinated monomers other than the fluorinated polyether monomer. More preferably, the fluorinated polyether monomer will comprise between 10% by weight and 75% by weight of units deriving from the fluorinated polyether monomer and between 90% and 25% by weight of units deriving from non-fluorinated monomers and/or other fluorinated monomers other than the fluorinated polyether monomer. In a particular preferred embodiment, the fluorinated polymer will comprise from 5 to 70% by weight of units deriving from the fluorinated polyether monomer, between 1 and 30% by weight of monomers comprising a cure site and between 0 and 94% by weight of other non-fluorinated monomers and/or fluorinated monomers other than the fluorinated polyether monomer.

The fluorinated polymer is typically prepared by free radical polymerisation e.g. by solution or mini-emulsion polymerisation techniques. Various surfactants such as anionic, cationic, non-ionic or amphoteric surfactants may be employed. They can be used alone or in combination. Alternatively, the polymerisation may be done in solvent. The polymerisation can be a thermal or photochemical polymerisation, carried out in the presence of a free radical initiator. Useful free radical initiators are known in the art and include azo compounds, such as azobisisobutyronitrile (AIBN), azobisvaleronitrile and azobis(2-cyanovaleric acid), 2,2′-azobis(2-amidinopropane)dihydrochloride and the like, hydroperoxides such as cumene, t-butyl, and t-amyl hydroperoxide, dialkyl peroxides such as di-t-butyl and dicumylperoxide, peroxyesters such as t-butylperbenzoate and di-t-butylperoxy phtalate, and diacylperoxides such as benzoyl peroxide and lauroyl peroxide.

The polymerisation may further be carried out in the presence of a chain transfer agent or a chain terminator to tailor the molecular weight and/or properties of the fluorochemical polymer. Typically, the fluorinated polymer has a weight average molecular weight between 5000 and 300 000, preferably between 5000 and 100 000.

Extender

In addition to the fluorinated polyether compound having a perfluorinated polyether moiety, the fluorochemical composition generally also includes an extender. The extender of the fluorochemical composition comprises a non-fluorinated organic compound comprising one or more blocked isocyanate groups and/or a carbodiimide compound. The extender used in the fluorochemical composition conveniently has a molecular weight of not more than 50,000 with a typical range being between 300 g/mol and 5,000 to 10,000 g/mol.

The non-fluorinated organic compound comprising one or more blocked isocyanate groups, hereinafter also called blocked isocyanate or blocked polyisocyanate, may be aromatic, aliphatic, cyclic or acyclic and is generally a blocked di- or triisocyanate or a mixture thereof and can be obtained by reacting an isocyanate with a blocking agent that has at least one functional group capable of reacting with an isocyanate group. Preferred blocked isocyanate extenders are blocked polyisocyanates that at a temperature of less than 150° C. are capable of reacting with an isocyanate reactive group, preferably through deblocking of the blocking agent at elevated temperature. Preferred blocking agents include arylalcohols such as phenols, lactams such as ε-caprolactam, δ-valerolactam, γ-butyrolactam, oximes such as formaldoxime, acetaldoxime, methyl ethyl ketone oxime, cyclohexanone oxime, acetophenone oxime, benzophenone oxime, 2-butanone oxime or diethyl glyoxime. Further suitable blocking agents include bisulfite and triazoles.

According to a particular embodiment of the invention, the blocked polyisocyanate may comprise the condensation product of a polyisocyanate, for example a di- or triisocyanate, a blocking agent and a non-fluorinated organic compound other than the blocking agent and having one or more isocyanate reactive groups such as a hydroxy, amino or thiol group. Examples of such organic compounds include monofunctional organic compounds, i.e., compounds that have only one group capable of reacting with an isocyanate as well as compounds that have two or more such groups. Particular examples of non-fluorinated organic compounds include monofunctional alcohols including monofunctional aliphatic alcohols e.g. mono-alkanols having at least 6 carbon atoms, monofunctional amines including monofunctional aliphatic amines, a polyoxyalkylenes having 2, 3 or 4 carbon atoms in the oxyalkylene groups and having 1 or 2 groups capable of reacting with an isocyanate group, polyols including diols such as polyether diols, polyester diols, dimer diols, fatty acid ester diols, polysiloxane diols and alkane diols such as ethylene glycol and polyamines.

In a particular embodiment, the non-fluorinated organic compound other than the isocyanate blocking agent may be an oligomer obtained by free radical oligomerization of non-fluorinated monomers in the presence of a chain transfer agent that is functionalised with a hydroxy or amino group. Examples of non-fluorinated monomers include those described above. Examples of suitable chain transfer agents include compounds that have the general formula:

HS—R^{h}-A (VIII)

wherein R^{h} represents a non-fluorinated organic divalent linking group or a chemical bond and A represents a functional group that has a Zerewitinoff hydrogen atom. Examples of functional groups A include amino groups, hydroxy and acid groups. Specific examples of functional chain transfer agents include 2-mercaptoethanol, mercaptoacetic acid, 2-mercaptobenzoic acid, 3-mercapto-2-butanol, 2-mercaptosulfonic acid, 2-mercaptoethylsulfide, 2-mercaptonicotinic acid, 4-hydroxythiophenol, 3-mercapto-1,2-propanediol, 1-mercapto-2-propanol, 2-mercaptopropionic acid, N-(2-mercaptopropionyl)glycine, 2-mercaptopyridinol, mercaptosuccinic acid, 2,3-dimercaptopropanesulfonic acid, 2,3-dimercaptopropanol, 2,3-dimercaptosuccinic acid, 2,5-dimercapto-1,3,4-thiadiazole, 3,4-toluenedithiol, o-, m-, and p-thiocresol, 2-mercaptoethylamine, ethylcyclohexanedithiol, p-menthane-2,9-dithiol and 1,2-ethanedithiol. Preferred functionalized end-capping agents include 2-mercaptoethanol, 3-mercapto-1,2-propanediol, 4-mercaptobutanol, 11-mercaptoundecanol, mercaptoacetic acid, 3-mercaptopropionic acid, 12-mercaptododecanoic acid, 2-mercaptoethylamine, 1-chloro-6-mercapto-4-oxahexan-2-ol, 2,3-dimercaptosuccinic acid, 2,3-dimercaptopropanol, 3-mercaptopropyltrimethoxysilane, 2-chloroethanethiol, 2-amino-3-mercaptopropionic acid, and compounds such as the adduct of 2-mercaptoethylamine and caprolactam.

Examples of further suitable organic compounds include the organic compounds described above for the preparation of the fluorinated polyether compound that is based on a condensation product of a fluorinated polyether, a polyisocyanate and an optional coreactant. According to a particularly preferred embodiment, the organic compound will include one or more water solubilizing groups or groups capable of forming water solubilizing groups so as to obtain a compound that can more easily be dispersed in water. Suitable water solubilizing groups include cationic, anionic and zwitter ionic groups as well as non-ionic water solubilizing groups. Examples of ionic water solubilizing groups include ammonium groups, phosphonium groups, sulfonium groups, carboxylates, sulfonates, phosphates, phosphonates or phosphinates. Examples of groups capable of forming a water solubilizing group in water include groups that have the potential of being protonated in water such as amino groups, in particular tertiary amino groups. Particularly preferred organic compounds are those organic compounds that have only one or two functional groups capable of reacting with NCO-group and that further include a non-ionic water-solubilizing group. Typical non-ionic water solubilizing groups include polyoxyalkylene groups. Preferred polyoxyalkylene groups include those having 1 to 4 carbon atoms such as polyoxyethylene, polyoxypropylene, polyoxytetramethylene and copolymers thereof such as polymers having both oxyethylene and oxypropylene units. The polyoxyalkylene containing organic compound may include one or two functional groups such as hydroxy or amino groups. Examples of polyoxyalkylene containing compounds include alkyl ethers of polyglycols such as e.g. methyl or ethyl ether of polyethyleneglycol, hydroxy terminated methyl or ethyl ether of a random or block copolymer of ethyleneoxide and propyleneoxide, amino terminated methyl or ethyl ether of polyethyleneoxide, polyethylene glycol, polypropylene glycol, a hydroxy terminated copolymer (including a block copolymer) of ethylene oxide and propylene oxide, a diamino terminated poly(alkylene oxide) such as Jeffamine™ ED, Jeffamine™ EDR-148 and poly(oxyalkylene)thiols.

Examples of polyisocyanates for preparing the blocked polyisocyanates extenders include aromatic as well as aliphatic polyisocyanates. Suitable polyisocyanates for the preparation of the blocked polyisocyanate extenders preferably are di- or triisocyanates as well as mixtures thereof. Specific examples are aromatic diisocyanates such as 4,4′-methylenediphenylenediisocyanate, 4,6-di-(trifluoromethyl)-1,3-benzene diisocyanate, 2,4-toluenediisocyanate, 2,6-toluene diisocyanate, o, m, and p-xylylene diisocyanate, 4,4′-diisocyanatodiphenylether, 3,3′-dichloro-4,4′-diisocyanatodiphenylmethane, 4,5′-diphenyldiisocyanate, 4,4′-diisocyanatodibenzyl, 3,3′-dimethoxy-4,4′-diisocyanatodiphenyl, 3,3′-dimethyl-4,4′-diisocyanatodiphenyl, 2,2′-dichloro-5,5′-dimethoxy-4,4′-diisocyanato diphenyl, 1,3-diisocyanatobenzene, 1,2-naphthylene diisocyanate, 4-chloro-1,2-naphthylene diisocyanate, 1,3-naphthylene diisocyanate, and 1,8-dinitro-2,7-naphthylene diisocyanate and aromatic tri-isocyanates such as polymethylenepolyphenylisocyanate.

Still further isocyanates that can be used for preparing a blocked isocyanate include alicyclic diisocyanates such as 3-isocyanatomethyl-3,5,5-trimethylcyclohexylisocyanate; aliphatic diisocyanates such as 1,6-hexamethylenediisocyanate, 2,2,4-trimethyl-1,6-hexamethylenediisocyanate, and 1,2-ethylenediisocyanate; aliphatic triisocyanates such as 1,3,6-hexamethylenetriisocyanate; aromatic tri-isocyanates such as polymethylenepolyphenylisocyanate (PAPI); cyclic diisocyanates such as isophorone diisocyanate (IPDI) and dicyclohexylmethane-4,4′-diisocyanate. Also useful are isocyanates containing internal isocyanate-derived moieties such as biuret-containing tri-isocyanates such as that available from Bayer as DESMODUR™ N-100, isocyanurate-containing tri-isocyanates such as that available from Huls AG, Germany, as IPDI-1890, and azetedinedione-containing diisocyanates such as that available from Bayer as DESMODUR™ TT. Also, other di- or tri-isocyanates such as those available from Bayer as DESMODUR™ L and DESMODUR™ W, and tri(4-isocyanatophenyl)-methane (available from Bayer as DESMODUR™ R) and DDI 1410 from Henkel are suitable. Commercially available blocked aromatic polyisocyanates include Baygard™ EDW available from Bayer Corp. and Hydrophobol™ XAN available from Ciba-Geigy. Further examples of blocked isocyanate compounds that may be used in the fluorochemical composition of this invention are disclosed in WO 99/14422.

The blocked isocyanate compounds can be produced by reacting a polyisocyanate compound with a blocking agent and optionally a non-fluorinated organic compound. Preferably, the blocked isocyanate compound is produced by reacting between 100% and 40% or the isocyanate groups with the blocking agent. The remainder of the isocyanate groups may be reacted with water and/or the optional non-fluorinated organic compound. Preferably, between 99 and 40% of the isocyanate groups are reacted with one or more blocking agents and between 1 and 60% of the isocyanate groups is reacted with one or more non-fluorinated organic compound. In a particular preferred embodiment, between 1 and 10% of the isocyanate groups are reacted with a non-fluorinated organic compound that has a water solubilizing group.

The extender may also comprise a carbodiimide compound as an alternative to or in admixture with the blocked isocyanate compounds. The carbodiimide compound can be an aromatic or aliphatic carbodiimide compound and may include a polycarbodiimide. Carbodiimides that can be used have been described in for example U.S. Pat. No. 4,668,726, U.S. Pat. No. 4,215,205, U.S. Pat. No. 4,024,178, U.S. Pat. No. 3,896,251, WO 93/22282, U.S. Pat. No. 5,132,028, U.S. Pat. No. 5,817,249, U.S. Pat. No. 4,977,219, U.S. Pat. No. 4,587,301, U.S. Pat. No. 4,487,964, U.S. Pat. No. 3,755,242 and U.S. Pat. No. 3,450,562. Particularly suitable carbodiimides for use in this invention include those corresponding to the formula (VIII):

R¹—[N═C═N—R³]ᵤ—N═C═N—R² (VIII)

wherein u has a value of 1 to 20, typically 1 or 2, R¹ and R² each independently represent a hydrocarbon group, in particular a linear, branched or cyclic aliphatic group preferably having 6 to 18 carbon atoms and R³ represents a divalent linear, branched or cyclic aliphatic group.

The aliphatic carbodiimide extenders of formula VIII can be synthesized in a 1-step process by reacting aliphatic diisocyanates with an aliphatic mono-isocyanate as a chain stopper at 130 to 170° C. in the presence of a phospholine oxide or other suitable carbodiimide formation catalyst. Preferably the reaction is carried out in the absence of solvents under inert atmosphere, but high-boiling non-reactive solvents such as methyl isobutyl ketone can be added as diluents. The mole ratio of diisocyanate to mono-isocyanate can be varied from 0.5 to 10, preferably 1 to 5.

Examples of aliphatic diisocyanates for the preparation of the carbodiimide compounds of formula (VIII) include isophorone diisocyanate, dimer diacid diisocyanate, 4,4′ dicyclohexyl methane diisocyanate. Examples of mono-isocyanates are n.butyl isocyanate and octadecyl isocyanate. Representative examples of suitable carbodiimide formation catalysts are described in e.g.; U.S. Pat. No. 2,941,988, U.S. Pat. No. 3,862,989 and U.S. Pat. No. 3,896,251. Examples include 1-ethyl-3-phospholine, 1-ethyl-3-methyl-3-phospholine-1-oxide, 3-methyl-1-phenyl-3-phospholine-1-oxide and bicyclic terpene alkyl or hydrocarbyl aryl phosphine oxide. The particular amount of catalyst used depends on the reactivity of the catalyst and the isocyanates being used. A concentration of 0.2 to 5 parts of catalyst per 100 g of diisocyanate is suitable.

In an alternative approach the aliphatic diisocyanates can be first reacted with monofunctional alcohols, amines or thiols followed by carbodiimide formation in a second step.

Fluorochemical Composition

The fluorochemical composition comprises a dispersion or solution of the fluorinated polyether compound and the extender in water or an organic solvent. The term “dispersion” in connection with this invention includes dispersions of a solid in a liquid as well as liquid in liquid dispersions, which are also called emulsions. Generally, the amount of fluorinated polyether compound contained in the treating composition is between 0.01 and 4% by weight, preferably between 0.05 and 3% by weight based on the total weight of the fluorochemical composition. Higher amounts of fluorinated polyether compound of more than 4% by weight, for example up to 10% by weight may be used as well, particularly if the uptake of the fluorochemical composition by the substrate is low. Generally, the fluorochemical treating composition will be prepared by diluting a more concentrated fluorochemical composition to the desired level of fluorinated polyether compound in the treating composition. The concentrated fluorochemical composition can contain the fluorinated polyether compound in an amount of up to 70% by weight, typically between 10% by weight and 50% by weight.

The extender or mixture of extenders is typically present in the fluorochemical composition in an amount of 0.05% to 3% of the total weight of a fluorochemical composition that is ready for treatment of the substrate. The amount of extender in a concentrated fluorochemical composition from which a treating composition may be prepared upon dilution is typically between 5% and 95% by weight of the total composition. Generally, the weight ratio of the total amount of extender to the total amount of the fluorinated polyether compound is between 5:95 and 95:5, preferably between 20:80 and 50:50.

When the fluorochemical composition is in the form of a dispersion in water or an organic solvent, the weight average particle size of the fluorinated polyether compound particles is preferably not more than 400 nm, more preferably is not more than 300 nm.

Most preferably, the fluorochemical composition is an aqueous dispersion of the fluorinated polyether compound. Such dispersion may be non-ionic, anionic, cationic or zwitterionic. The dispersion is preferably stabilised using non-fluorinated surfactants, such as non-ionic polyoxyalkylene, in particular polyoxyethylene surfactants, anionic non-fluorinated surfactants, cationic non-fluorinated surfactants and zwitterionic non-fluorinated surfactants. Specific examples of non-fluorinated surfactants that can be used are nonionic types such as Emulsogen™ EPN 207 (Clariant) and Tween™ 80 (ICI), anionic types such as lauryl sulfate and sodium dodecyl benzene sulfonate, cationic types such as Arquad™ T-50 (Akzo), Arquad™ 2C-75 (Akzo), Arquad™ 2HT (Akzo), Ethoquad™ 18-25 (Akzo), salts of Rewopon™ IMOA or Rewopon™ IM or amphoteric types such as lauryl amineoxide and cocamido propyl betaine. The non-fluorinated surfactant is preferably present in an amount of about 1 to about 25 parts by weight, preferably about 2 to about 10 parts by weight, based on 100 parts by weight of the fluorochemical composition.

Alternatively, a solution or dispersion of the fluorinated polyether compound in an organic solvent can be used as the fluorochemical treating composition. Suitable organic solvents include alcohols such as isopropanol, methoxy propanol and t.butanol, ketones such as isobutyl methyl ketone and methyl ethylketone, ethers such as isopropylether, esters such ethylacetate, butylacetate or methoxypropanol acetate or (partially) fluorinated solvents such as HCFC-141b, HFC-4310mee and hydrofluoroethers such as HFE-7100 or HFE-7200 available from 3M Company.

The fluorochemical composition may contain further additives such as buffering agent, agents to impart fire proofing or antistatic properties, fungicidal agents, optical bleaching agents, sequestering agents, mineral salts and swelling agents to promote penetration. The fluorochemical composition may contain also further fluorochemical compounds other than the fluorinated polyether compound. For example, the fluorochemical composition may contain fluorochemical compounds that are based on or derived from perfluoroaliphatic compounds. Nevertheless, it is not necessary to include such compounds in the fluorochemical composition. Also, if perfluoroaliphatic based compounds are included in the composition, they are preferably compounds based on short chain perfluoroaliphatics such as compounds containing C₄F₉— groups.

In a preferred embodiment of the present invention, the fluorochemical composition will be free of or substantially free of perfluorinated polyether moieties having a molecular weight of less than 750 g/mol and/or perfluoroaliphatic groups of more than 5 or 6 carbon atoms. By the term “perfluoroaliphatic groups” is meant groups consisting of carbon and fluorine without including perfluorinated end groups of the perfluorinated polyether moieties. By the term “substantially free of” is meant that the particular perfluorinated polyether moieties are present in amounts of not more than 10% by weight, preferably not more than 5% by weight and most preferably not more than 1% by weight based on the total weight of perfluorinated polyether moieties in the composition and that the particular perfluoroaliphatic groups having more than 5 or 6 carbons are present in amounts of not more than 10% by weight, preferably not more than 5% by weight and most preferably not more than 1% by weight based on the total weight of perfluoroaliphatic groups in the composition. Compositions that are free of or substantially free of these moieties or groups are preferred because of their beneficial environmental properties.

Method of Treatment

In order to affect treatment of the fibrous substrate the fibrous substrate is contacted with the fluorochemical composition of the invention. For example, the substrate can be immersed in the fluorochemical treating composition. The treated substrate can then be run through a padder/roller to remove excess fluorochemical composition and dried. The treated substrate may be dried at room temperature by leaving it in air or may alternatively or additionally be subjected to a heat treatment, for example, in an oven. This heat treatment is typically carried out at temperatures between about 50° C. and about 190° C. depending on the particular system or application method used. In general, a temperature of about 120° C. to 170° C., in particular of about 150° C. to about 170° C. for a period of about 20 seconds to 10 minutes, preferably 3 to 5 minutes, is suitable. Alternatively, the chemical composition can be applied by spraying the composition on the fibrous substrate.

It was found that with fluorochemical composition of this invention, good to excellent oil- and/or water repellent properties on the fibrous substrate can be achieved. Moreover, these properties can be achieved without subjecting the fibrous substrate to a heat treatment, i.e. the properties can be achieved upon air drying the fibrous substrate after the application of the composition. Also, it was observed that the repellency properties are durable, i.e., even after several washing or dry cleaning cycles, the repellency properties can be substantially maintained. The compositions furthermore in many instances do not negatively affect the soft feel of the fibrous substrates or may even improve the soft feel of the fibrous substrate.

The amount of the treating composition applied to the fibrous substrate is chosen so that a sufficiently high level of the desired properties are imparted to the substrate surface preferably without substantially affecting the look and feel of the treated substrate. Such amount is usually such that the resulting amount of the fluorinated compound(s) on the treated fibrous substrate will be between 0.05% and 3% by weight, preferably 0.2% to 1% by weight based on the weight of the fibrous substrate. The amount which is sufficient to impart desired properties can be determined empirically and can be increased as necessary or desired. According to a particularly preferred embodiment, the treatment is carried with a composition and under conditions such that the total amount of perfluorinated polyether groups having a molecular weight of less than 750 g/mol and/or perfluoroaliphatic groups of more than 6 carbon atoms is not more than 0.1%, preferably not more than 0.05% by weight based on the weight of the fibrous substrate.

Fibrous substrates that can be treated with the fluorochemical composition include in particular textile and carpet. The fibrous substrate may be based on synthetic fibers, e.g. polyester, polyamide and polyacrylate fibers or natural fibers, e.g. cellulose fibers as well as mixtures thereof. The fibrous substrate may be a woven as well as a non-woven substrate.

The invention will now be further illustrated with reference to the following examples without the intention to limit the invention thereto. All parts and percentages are by weight unless stated otherwise.

### EXAMPLES

Formulation and Treatment Procedure:

Treatment baths were formulated containing a defined amount of the fluorochemical composition. Treatments were applied to the test substrates by padding to provide a concentration as indicated in the examples (based on fabric weight and indicated as SOF (solids on fabric)). Samples were air dried at ambient temperature for 24-48 hours followed by conditioning at 21° C. and 50% relative humidity for 2 hours (air cure). Alternatively, the samples were dried and cured at 160° C. during 1.5 minutes or at 150° C. during 10 minutes, as indicated in the examples.

After drying and heat cure, the substrates were tested for their repellency properties.

Substrates used for the evaluation of treatments of this invention were commercially available and are listed below:

IND: “Imported Nexday Twill” 100% ring spun cotton, dyed unfinished from Avondale mills in Graniteville S.C., USA;

SHIPP: “Super Hippagator” 100% ring/OE spun cotton, dyed unfinished from Avondale Mills in Graniteville S.C., USA;

PES/Co (2681.4): polyester/cotton 65/35 fabric, style no. 2681.4, available from Utexbel N.V., Ronse, Belgium;

PAμ (7819.4): 100% polyamide microfiber, style no. 7819.4, available from Sofinal, Belgium;

Co (1511.1): 100% cotton: bleached, mercerized cotton poplin, style no. 1511.1, available from Utexbel N.V., Ronse, Belgium; and

PESμ (6145.3): 100% polyester microfiber, style no. 6145.3, available from Sofinal, Belgium

Respective data of water and oil repellency shown in the Examples and Comparative Examples were based on the following methods of measurement and evaluation criteria:

Spray Rating (SR)

The spray rating of a treated substrate is a value indicative of the dynamic repellency of the treated substrate to water that impinges on the treated substrate. The repellency was measured by Standard Test Number 22, published in the 1985 Technical Manual and Yearbook of the American Association of Textile Chemists and Colorists (AATCC), and was expressed in terms of ‘spray rating’ of the tested substrate. The spray rating was obtained by spraying 250 ml water on the substrate from a height of 15 cm. The wetting pattern was visually rated using a 0 to 100 scale, where 0 means complete wetting and 100 means no wetting at all.

Water Repellency Test (WR)

The water repellency (WR) of a substrate was measured using a series of water-isopropyl alcohol test liquids and was expressed in terms of the “WR” rating of the treated substrate. The WR rating corresponded to the most penetrating test liquid that did not penetrate or wet the substrate surface after 10 seconds exposure. Substrates which were penetrated by 100% water (0% isopropyl alcohol), the least penetrating test liquid, were given a rating of 0; substrates resistant to 100% water were given a rating W and substrates resistant to 100% isopropyl alcohol (0% water), the most penetrating test liquid, were given a rating of 10. Other intermediate ratings were calculated by dividing the percent isopropylalcohol in the test liquid by 10, e.g., a treated substrate resistant to a 70%/30% isopropyl alcohol/water blend, but not to an 80%/20% blend, would be given a rating of 7.

Oil Repellency (OR)

The oil repellency of a substrate was measured by the American Association of Textile Chemists and Colorists (AATCC) Standard Test Method No. 118-1983, which test was based on the resistance of a treated substrate to penetration by oils of varying surface tensions. Treated substrates resistant only to Nujol® mineral oil (the least penetrating of the test oils) were given a rating of 1, whereas treated substrates resistant to heptane (the most penetrating of the test liquids) were given a rating of 8. Other intermediate values were determined by use of other pure oils or mixtures of oils, as shown in the following table.

Standard Test Liquids

| AATCC Oil Repellency | |
|---|---|
| Rating Number | Compositions |
| 1 | Nujol ® |
| 2 | Nujol ®/n-Hexadecane 65/35 |
| 3 | n-Hexadecane |
| 4 | n-Tetradecane |
| 5 | n-Dodecane |
| 6 | n-Decane |
| 7 | n-Octane |
| 8 | n-Heptane |

Laundering Procedure 1 (HL Ironing)

The procedure set forth below was used to prepare treated substrate samples designated in the examples below as “5 Home Launderings-Ironing (5HL-Ironing)”. A sheet of treated substrate (generally square 400 cm² to about 900 cm²) was placed in a washing machine (Miele W 724) along with a ballast sample (at least 1.4 kg of 90×90 cm² hemmed pieces of approximately 250 g/m unfinished sheeting substrate, either cotton or 50/50 polyester/cotton, available from Test Fabrics, Inc., New Jersey, USA). The total weight of the treated substrates and ballast should be 1.8+/−0.2 kg. 60 g IEC Test Detergent with perborate, Type I (available through common detergent suppliers) was added and the washer was filled with 30 l water. The water was heated to 40° C.+/−3° C. The substrate and ballast load were washed 5 times, followed by five rinse cycles and centrifuging. The samples were not dried between repeat cycles. After the washes, the treated substrate and dummy load were dried together in a dryer at 65° C., for 45+−5 minutes. After drying, the treated substrate was pressed for 15 seconds, using an iron set at a temperature of 150-160° C.

Laundering Procedure 2 (HL)

The procedure set forth below was used to prepare treated substrate samples designated in the examples below as “5 Home Launderings (5HL)”

A 230 g sample of generally square, 400 cm² to about 900 cm² sheets of treated substrate was placed in a washing machine along with a ballast sample (1.9 kg of 8 oz fabric in the form of generally square, hemmed 8100 cm² sheets). A commercial detergent (“Tide Ultra”, Liquid, Deep Cleaning Formula, available from Proctor and Gamble, 90 g) was added and the washer was filled to high water level with hot water (41° C.+−2° C.). The substrate and ballast load were washed five times using a 12-minute normal wash cycle.

The substrate and ballast were dried together in a conventional tumble drier at 65+−5° C. during 45+−5 minutes. Before testing, the substrates were conditioned at room temperature during about 4 hours.

HL (10 Home Launderings) or 30 HL (30 Home Launderings) indicated that the substrate was washed 10 or 20 times respectively according to the procedure above.

Glossary

| Descriptor | Formula/Structure | Availability |
|---|---|---|
| trifluorotoluene | C₆H₅CF₃ | Sigma-Aldrich, |
| | | Milwaukee, WI |
| DBTDL | Dibutyl tin dilaurate; | Sigma-Aldrich; |
| | (CH₃(CH₂)₁₀CO₂)₂ | Milwaukee, WI |
| | Sn((CH₂)₃CH₃)₂ | |
| Des N-100 | DESMODUR ™ N 100; | Bayer, Pittsburgh. |
| | Polyfunctional isocyanate resin | PA |
| | based on hexamethylene | |
| | diisocyanate | |
| Des N-3300 | DESMODUR ™ N 3300; | Bayer |
| | Polyfunctional isocyanate resin | |
| | based on hexamethylene | |
| | diisocyanate | |
| Des W | DESMODUR ™ W; methylene | Bayer |
| | bis(4-cyclohexyl isocyanate) | |
| ETHOQUAD ™ | Methyl | Akzo, Arnhem, |
| 18/25 | polyoxyethylene(15)octadecyl | Netherlands |
| | ammonium chloride | |
| HFE-7100 | Perfluorobutyl methyl ether; | 3M, St Paul, MN |
| | C₄F₉OCH₃ | |
| Isofol 18T | 2-alkylalkanol | Condea, |
| | | Brunsbuttel, |
| | | Germany |
| IPDI | Isophorone diisocyanate | Merck KgaA, |
| | | Germany |
| MPEG-750 | methoxypolyethylene glycol | Union Carbide, |
| | (MW 750) | Danbury, CT |
| MEKO | 2-Butanone oxime; | Sigma-Aldrich |
| | CH₃C(═NOH)C₂H₅ | |
| MIBK | Methyl isobutyl ketone | Sigma-Aldrich |
| MONDUR ™ MR | Aromatic polymeric isocyanate | Bayer |
| | based on diphenylmethane- | |
| | diisocyanate | |
| ODI | Octadecyl isocyanate; | Sigma-Aldrich |
| | CH₃(CH₂)₁₇NCO | |
| PAPI | VORANATE ™ M220: | Dow Chemical, |
| | polymethylene polyphenyl | Midland, MI |
| | isocyanate | |
| UNILIN ™ 350 | Polyethylene alcohol; | Baker, Petrolite; |
| | MW_{avg} = 350 | Tulsa, OK |
| PEG-400 | Polyethylene glycol MW = 400 | Aldrich Chemical |
| | | Co. |

(HFPO)ₖ-alc: HFPO oligomer alcohols, CF₃CF₂CF₂—O(CF(CF₃)CF₂O)ₙCF(CF₃)CONHCH₂CH₂OH, consisting of a mixture of oligomers with different chain lengths. The indexes k and n are indicative of the mathematical average of the number of repeating HFPO-units and k=n+2. The percentage of oligomeric alcohols with a fluorinated polyether group having a molecular weight lower than 750 g/mol was 3.2% for (HFPO)_{11.5}-alc; 5.7% for (HFPO)_{8.8}-alc and 15.9% for (HFPO)_{5.5}-alc. (4-1)ODA-ol: oligomer alcohol, prepared from octadecylacrylate/2-mercaptoethanol 4/1, according to U.S. Pat. No. 6,239,247 B1, column 12, lines 50-59.

I. Synthesis of Fluorochemical Polyether Derivatives (Table 1)

A. Synthesis of Fluorochemical Polyether Alcohol Derivatives (HFPO)ₖ-alc

Several HFPO-oligomer alcohols (HFPO)ₖ-alc were prepared according to the general procedure as given for the synthesis of CF₃CF₂CF₂—O—(CF(CF₃)CF₂O)_{6.8}CF(CF₃)CONHCH₂CH₂OH, indicated in table 1 as (HFPO)_{8.8}-alc.

A 1 liter 3-necked reaction flask was equipped with a stirrer, a condenser, a dropping funnel, a heating mantle and a thermometer. The flask was charged with 1000 g CF₃CF₂CF₂—O—(CF(CF₃)CF₂O)_{6.8}CF(CF₃)COOCH₃. The mixture was heated to 40° C. and 43.4 g ethanol amine was added via the dropping funnel, over a period of 30 minutes. The reaction mixture was kept at 65° C. during 3 hours. FTIR analysis indicated complete conversion. The end product could be purified as follows: 500 ml ethyl acetate were added and the organic solution was washed with 200 ml HCL (1N), followed by 2 washings with 200 ml brine. The organic phase was dried over MgSO₄. Ethyl acetate was evaporated with water jet vacuum, using a Büchi rotary evaporator. The product was dried at 50° C. during 5 hours, using oil pump vacuum (<1 mbar). An alternative purification step included evaporation of methanol, formed during reaction, via water jet vacuum, using a Büchi rotary evaporator (up to 75° C.=<100 mm Hg). Residual methanol was further removed with oil pump vacuum (up to 80° C., =<10 mbar).

The HFPO-oligomer alcohol (HFPO)_{8.8}-alc obtained, was a yellow coloured oil, with medium viscosity. The structure was confirmed by means of NMR.

HFPO-oligomer alcohols with other chain lengths were prepared essentially according to the same procedure.

B. Synthesis of Fluorchemical Polyether Urethane Derivatives

1. Synthesis of HFPO_{8.8}-alc/PAPI/MEKO (1/1/2) (FC-2)

In a first step, 20 g (HFPO)_{8.8}-alc was charged into a 3-necked reaction flask, equipped with a magnetic stirring bar, a condenser, a thermometer, a heating mantle and a nitrogen inlet. 38.5 g ethyl acetate and 3 g HFE-7100 were added to obtain a clear solution. 5.4 g PAPI were added, followed by a slow addition of 2.3 g MEKO (through a syringe). The reaction was run at 75° C. during 6 hours. An additional 0.46 g MEKO was added and the reaction was continued at 75° C. during 6 hours. FTIR analysis indicated complete conversion.

In a second step, the fluorochemical polyether urethane FC-2 was emulsified. The reaction mixture was dispersed in water containing Ethoquad™ 18/25 (5% on solids) using a Branson 450 sonifier (2 minutes u-sound at 65° C.). The solvent was stripped off with waterjet vacuum, using a Büchi rotary evaporator. A stable milky dispersion was obtained

2. Synthesis of Fluorochemical Polyether Urethanes FC-3 to FC-7

Fluorochemical polyether urethanes FC-3 to FC-7 were made according to the general procedure as given for the synthesis of (HFPO)_{8.8}-alc/Des N-3300/Unilin™ 350 (2/1/1.3), indicated as FC-3. A round bottom flask, equipped with a magnetic stirring bar, a condenser, a thermometer, a heating mantle and a nitrogen inlet was charged with 50 ml trifluorotoluene, 5 g (0.00756 moles) Des N-3300 and 23.8 g (0.0151 moles) (HFPO)_{8.8}-alc. 1 drop of DBTDL was added and the mixture was heated to 95° C. during 1 hour, before Unilin™ 350 (4.3 g or 0.0098 moles) was added. The reaction mixture was stirred at 95° C. during 6 hours. FTIR indicated completion of the reaction. In a second step the fluorochemical polyether urethane was emulsified. The reaction mixture was dispersed in water containing Ethoquad™ 18/25 (5% on solids) using a Branson 450 sonifier (4 minutes u-sound at 65° C.). The solvent was stripped with a water jet aspirator using a Büchi rotary evaporator. A stable milky dispersion was obtained.

Fluorochemical polyether urethane derivatives FC-4 to FC-7 were made according to the same procedure, and in molar ratios as given in table 1.

3. Synthesis of Fluorochemical Polyether Urethane FC-8

A reaction flask was charged with 100 g trifluorotoluene, Desmodur N-3300 and (HFPO)_{8.8}-alc in amounts to provide the molar ratio as given in Table 1. 1 drop of DBTDL was added and the mixture was heated at 95° C. during 1 hour. (4-1)ODA-ol was added and the mixture was heated at 75° C. during 12 hours. FT-IR analysis indicated complete conversion. In a second step the fluorochemical polyether urethane was emulsified. The reaction mixture was dispersed in water containing Ethoquad™ 18/25 (5% on solids) using a Branson 450 sonifier (4 minutes u-sound at 65° C.). The solvent was stripped with a water jet aspirator using a Büchi rotary evaporator. A stable milky dispersion was obtained.

TABLE 1
composition of FC polyether derivatives

| Number | Composition | Ratio (molar) |
|---|---|---|
| FC-1 | (HFPO)_{11.5}-alc | |
| FC-2 | (HFPO)_{8.8}-alc/PAPI/MEKO | 1/1/2 |
| FC-3 | (HFPO)_{8.8}-alc/Des N-3300/Unilin 350 | 2/1/1.3 |
| FC-4 | (HFPO)_{5.5}-alc/Des N-100 | 3/1 |
| FC-5 | (HFPO)_{11.5}-alc/Des N-100 | 3/1 |
| FC-6 | (HFPO)_{5.5}-alc/Des N 100/MEKO | 2/1/1 |
| FC-7 | (HFPO)_{11.5}-alc/Des N-100/MEKO | 2/1/1 |
| FC-8 | (HFPO)_{8.8}-alc/Des N-3300/(4-1)ODA-ol | 2.3/1/1 |

II. Synthesis of Extenders (Table 2)

A. Synthesis of Blocked Isocyanate Extenders EXT-1 to EXT-3

a. Synthesis of PAPI/PEG-400/MEKO (1/2.94/0.3) (EXT-1)

A 3-necked reaction flask, equipped with a stirrer, heating mantle, thermometer and nitrogen inlet was charged with 36.72 g PAPI, 25.58 g MEKO, 1.2 g PEG-400 and 63.5 g ethyl acetate. 4 drops of DBTDL were added and the reaction was run at 75° C. during 4 hours. FTIR indicated completion of reaction. The reaction mixture was dispersed in water containing ETHOQUAD™ 18/25 (5% on solids) using a Branson 450 sonifier (2 minutes u-sound at 65° C.). The solvent was stripped off with waterjet vacuum, using a Büchi rotary evaporator. A stable 20% solids dispersion was obtained.

b. Synthesis of Mondur MR (MPEG750/MEKO/H₂O) (EXT-2)

A round bottom reaction flask, equipped with a stirrer, heating mantle, thermometer and nitrogen inlet was charged with Mondur MR (66.0 g), MPEG 750 (8.64 g), and MIBK (74.6 g) was heated to 62° C. over 7 min under a blanket of nitrogen. Then DBTDL (0.11 g) was added. The solution was stirred at 62° C. for 70 minutes and a solution of MEKO (24.4 g) and MIBK (24.4 g) was added over 1 hr. There was an exotherm with the temperature rising from 64.5° C. to 71.5° C.) over the first 7.5 minutes, then the solution was stirred at 71.5° C., decreasing to 66° C. for 90 minutes. An FTIR after 1 hr showed that the 81.4 eq % of the isocyanate had reacted. The resulting solution was then poured into water (572.6 g), sonified for about 10 min, and stripped using rotary evaporator and an ambient temperature bath, giving a stable emulsion. Wt % solids=39.56 wt %.

B. Synthesis of Polycarbodiimide Extenders

a. Synthesis of IPDI/ODI 2/1 (EXT-3)

A 3 necked reaction flask equipped with a thermometer, reflux condenser, mechanical stirrer, heating mantle and nitrogen inlet, was charged with 111 g IPDI and 73.87 g ODI. The temperature was raised to 70° C. and 11.1 g a hydrocarbyl aryl phosphine oxide catalyst was added. The reaction mixture was heated at 150-160° C. overnight. FTIR analysis indicated complete conversion. After cooling, ethyl acetate was added to obtain 40% solids. In a second step, the polycarbodiimide was emulsified. The reaction mixture was dispersed in water containing Ethoquad 18/25 (5% on solids) using a Branson 450 sonifier (2 minutes u-sound at 65° C.). The solvent was stripped off with waterjet vacuum, using a Büchi rotary evaporator. A stable 20% solids dispersion was obtained.

b. Synthesis of Des W/Isofol 18 T 2/1 (EXT-4)

A 3 necked reaction flask equipped with a thermometer, reflux condenser, mechanical stirrer, heating mantle and nitrogen inlet, was charged with 78.6 g Des W and 42.9 g Isofol 18T. The reaction mixture was heated to 50° C. and 2 drops of DBTDL were added. The urethane reaction was done at 70° C. during 4 hours. In a second step, the polycarbodiimide was formed. A hydrocarbyl aryl phosphine oxide catalyst (2%) was added to the reaction mixture and the reaction was run at 150° C. overnight. FTIR confirmed complete conversion of isocyanate groups. The polycarbodiimide was emulsified as described for IPDI/ODI 2/1.

TABLE 2
Composition of extenders

| Number | Composition | Ratio (molar) |
|---|---|---|
| EXT-1 | PAPI/PEG-400/MEKO | 1/2.94/0.3 |
| EXT-2 | Mondur MR/(MPEG 750/MEKO/H₂O) | 1/(0.023/0.565/0.412) |
| EXT-3 | IPDI/ODI | 2/1 |
| EXT-4 | Des W/Isofol 18T | 2/1 |

### Examples 1 to 12 and Comparative Examples C-1 to C-4

In examples 1 to 12, different substrates were treated with fluorochemical polyether urethane FC-2 in combination with blocked isocyanate and carbodiimide extenders, as indicated in table 3, so as to give 0.3% SOF FC-2 and 0.1% SOF extender. Comparative examples C-1 to C-4 were made using 0.3% SOF FC-2, but no extender. After treatment the fabrics were dried at 160° C. during 1.5 minutes. The treated substrates were tested for their oil and water repellency initially and after 5 HL The results are summarized in table 3.

TABLE 3
Substrates treated with FC polyether urethanes and extender

| | | |
|---|---|---|
| Ex | Initial | 5HL Ironing |

| | | | | | | | |
|---|---|---|---|---|---|---|---|
| No | Extender | OR | WR | SR | OR | WR | SR |

PESμ (6145.3)

| | | | | | | | |
|---|---|---|---|---|---|---|---|
| 1 | Ext-1 | 0.5 | 2 | 95 | 0 | 1 | 90 |
| 2 | Ext-3 | 0 | 2 | 95 | 0 | 1 | 80 |
| 3 | Ext-4 | 0.5 | 2 | 100 | 0 | 1 | 80 |
| C-1 | / | 1 | 1 | 95 | 0 | 1 | 75 |

PAμ (7819.4)

| | | | | | | | |
|---|---|---|---|---|---|---|---|
| 4 | Ext-1 | 3 | 3 | 80 | 1 | 1 | 60 |
| 5 | Ext-3 | 2 | 3 | 75 | 1 | 1 | 60 |
| 6 | Ext-4 | 2 | 3 | 70 | 1 | 1 | 60 |
| C-2 | / | 3 | 2 | 70 | 0.5 | 1 | 50 |

PES/Co (2681.4)

| | | | | | | | |
|---|---|---|---|---|---|---|---|
| 7 | Ext-1 | 3.5 | 3 | 95 | 1 | 1 | 75 |
| 8 | Ext-3 | 3.5 | 2.5 | 90 | 1 | 1 | 70 |
| 9 | Ext-4 | 3 | 2.5 | 85 | 0.5 | 1.5 | 70 |
| C-3 | / | 4 | 2 | 80 | 1 | 1 | 70 |

Co (1511.1)

| | | | | | | | |
|---|---|---|---|---|---|---|---|
| 10 | Ext-1 | 3 | 3 | 100 | 2 | 1.5 | 90 |
| 11 | Ext-3 | 2 | 2 | 100 | 1 | 1 | 80 |
| 12 | Ext-4 | 2 | 2 | 100 | 1 | 1 | 75 |
| C-4 | / | 2 | 2 | 90 | 1 | 1 | 60 |

The results indicated that substrates having high and especially durable oil repellency could be made when they were treated with FC polyether urethanes in combination with extenders, even at very low levels. In all cases improved water repellency was noticed, combined with equal or better oil repellency.

### Examples 13 to 34 and Comparative Examples C-5 and C-6

In examples 13 to 34, the influence of the add-on level of the extender in combination with fluorochemical polyether urethane was evaluated. Cotton samples were treated with compositions containing a variety of FC polyethers, as given in table 4, in combination with extender EXT-2, so as to give 0.5% SOF FC and % SOF extender as given in table 4. Comparative examples C-5 and C-6 were made using FC polyether FC-1 alone, without addition of extender. After treatment, the samples were cured at 150 C. during 10 minutes. Oil and water repellency were evaluated initially and after several home launderings. The results are given in Table 4.

TABLE 4

| | | % | | | | | | | | |
|---|---|---|---|---|---|---|---|---|---|---|
| Ex | | SOF | Initial | | 5 HL | | 10 HL | | 30 HL | |
| No | FC | Ext-2 | OR | SR | OR | SR | OR | SR | OR | SR |

IND

| | | | | | | | | | | |
|---|---|---|---|---|---|---|---|---|---|---|
| 13 | FC-1 | 0.5 | 5 | 85 | 5 | 80 | 4 | 80 | 3 | 50 |
| 14 | FC-1 | 1 | 5 | 100 | 4 | 90 | 4 | 90 | 4 | 50 |
| C-5 | FC-1 | / | 1 | 0 | 0 | 0 | 0 | 0 | 0 | 0 |

SHIPP

| | | | | | | | | | | |
|---|---|---|---|---|---|---|---|---|---|---|
| 15 | FC-1 | 0.5 | 5 | 70 | 4 | 70 | 4 | 70 | 3 | 70 |
| 16 | FC-1 | 1 | 5 | 80 | 4 | 70 | 4 | 80 | 3 | 50 |
| 17 | FC-3 | 0.25 | 4.5 | 80 | 4 | 75 | 3 | 70 | 1 | 50 |
| 18 | FC-3 | 0.5 | 4 | 80 | 4 | 80 | 4 | 75 | 2 | 60 |
| 19 | FC-3 | 1 | 4 | 80 | 4 | 80 | 4 | 75 | 2 | 70 |
| 20 | FC-4 | 0.25 | 5 | 80 | 5 | 70 | 5 | 50 | 4 | 0 |
| 21 | FC-4 | 0.5 | 5 | 80 | 5 | 75 | 5 | 75 | 4 | 60 |
| 22 | FC-4 | 1 | 5 | 80 | 5 | 80 | 5 | 80 | 4 | 60 |
| 23 | FC-5 | 0.25 | 5 | 70 | 5 | 60 | 4 | 50 | 3 | 0 |
| 24 | FC-5 | 0.5 | 5 | 80 | 4.5 | 80 | 4 | 80 | 4 | 60 |
| 25 | FC-5 | 1 | 5 | 85 | 4 | 85 | 4 | 80 | 3.5 | 70 |
| 26 | FC-6 | 0.25 | 5 | 75 | 5 | 70 | 4.5 | 70 | 4 | 50 |
| 27 | FC-6 | 0.5 | 5 | 80 | 5 | 80 | 5 | 80 | 4 | 70 |
| 28 | FC-6 | 1 | 5 | 80 | 5 | 80 | 4.5 | 80 | 4 | 75 |
| 29 | FC-7 | 0.25 | 5 | 75 | 5 | 75 | 4.5 | 50 | 3 | 50 |
| 30 | FC-7 | 0.5 | 5 | 80 | 5 | 80 | 4.5 | 80 | 4 | 70 |
| 31 | FC-7 | 1 | 5 | 80 | 4 | 80 | 4 | 80 | 4 | 75 |
| 32 | FC-8 | 1 | 4.0 | 80 | 4 | 80 | 3.5 | 80 | 2.0 | 70 |
| 33 | FC-8 | 0.5 | 4.5 | 80 | 4 | 80 | 3.5 | 75 | 2.0 | 50 |
| 34 | FC-8 | 0.25 | 4.5 | 75 | 3 | 75 | 3 | 70 | 2.0 | 60 |
| C-6 | FC-1 | / | 2 | 0 | 0 | 0 | 0 | 0 | 0 | 0 |

As can be seen from the results in table 4, very strong and durable oil repellency could be achieved on cotton, when fluorochemical polyether urethane derivatives were applied in combination with blocked isocyanate extender. Furthermore, a remarkably increase in both oil and water repellency was obtained when fluorochemical polyether alcohol was mixed with extender, even at low levels of extender added. High durability of water repellency and especially of the oil repellency was observed, even after repeated home launderings.

1. Fluorochemical composition suitable for rendering a fibrous substrate oil and/or water repellent without substantially adversely affecting the look and/or feel of the fibrous substrate, comprising a fluorinated polyether compound and an extender, wherein said fluorinated polyether compound comprises one or more perfluorinated polyether groups and wherein said extender comprises a non-fluorinated organic compound comprising one or more blocked isocyanate groups and/or a carbodiimide compound.

2. Fluorochemical composition according to claim 1 wherein said one or more perfluorinated polyether groups have a molecular weight of at least 750 g/mol.

3. Fluorochemical composition according to claim 2 wherein said composition is free of perfluoroaliphatic groups of more than 6 carbon atoms other than perfluorinated end groups of a perfluorinated polyether moiety and/or perfluorinated polyether groups having a molecular weight of less than 750 g/mol or wherein said composition contains said perfluoroaliphatic groups of more than 6 carbon atoms in an amount of not more than 10% by weight based on the total weight of perfluoroaliphatic groups other than end groups of a perfluorinated polyether moieties and/or contains said perfluorinated polyether groups having a molecular weight of less than 750 g/mol in an amount of not more than 10% by weight based on the total weight of perfluorinated polyether moieties in the fluorochemical composition.

4. Fluorochemical composition according to claim 1 wherein said fluorinated polyether compound corresponds to the general formula:
R_{f}-Q-Tₖ (ii)
wherein R_{f} represents a monovalent perfluorinated polyether group, Q represents a chemical bond or a divalent or trivalent organic linking group, T represents a functional group having one or more Zerewitinoff hydrogen atoms and k is 1 or 2.

5. Fluorochemical composition according to claim 1 wherein said perfluorinated polyether group corresponds to the formula:
R¹_{f}—O—R_{f}²—(R_{f}³)_{q}—
wherein R¹_{f} represents a perfluorinated alkyl group, R_{f}² represents a perfluorinated polyalkyleneoxy group consisting of perfluorinated alkyleneoxy groups having 1, 2, 3 or 4 carbon atoms or a mixture of such perfluorinated alkylene oxy groups, R³_{f} represents a perfluorinated alkylene group and q is 0 or 1.

6. Fluorochemical composition according to claim 4 wherein R²_{f} corresponds to the formula:
—[CF(CF₃)—CF₂O]ₙ—
wherein n is an integer of 3 to 25.

7. Fluorochemical composition according to claim 1 wherein said fluorinated polyether compound comprises the reaction product of (i) one or more perfluorinated ether compounds as defined in claim 4, (ii) a polyisocyanate compound having two or more isocyanate groups or a mixture of polyisocyanate compounds, and (iii) optionally one or more coreactants capable of reacting with an isocyanate group.

8. Fluorochemical composition according to claim 6 wherein said coreactant comprises an isocyanate blocking agent.

9. Fluorochemical composition according to claim 8 wherein said isocyanate blocking agent is selected from the group consisting of arylalcohols, lactams, oximes, bisulfite and triazoles.

10. Fluorochemical composition according to claim 7 wherein said coreactant comprises a non-fluorinated organic compound having one or more Zerewitinoff hydrogen atoms.

11. Fluorochemical composition according to claim 7 wherein said non-fluorinated compound is selected from a monofunctional alcohol, a monofunctional amine, a polyol and a polyamine.

12. Fluorochemical composition according to claim 1 wherein said fluorinated polyether compound comprises a fluoropolymer of one or more fluorinated monomers having an ethylenically unsaturated group and a perfluorinated polyether group.

13. Fluorochemical composition according to claim 12 wherein said fluoropolymer is a copolymer of said one or more fluorinated monomers and one or more non-fluorinated monomers.

14. Fluorochemical composition according to claim 1 wherein said non-fluorinated organic compound comprising one or more blocked isocyanate groups is an organic compound obtained by reacting a polyisocyanate compound having two or more isocyanate groups, an isocyanate blocking agent and optionally one or more co-reactants.

15. Fluorochemical composition according to claim 14 wherein said isocyanate blocking agent is selected from the group consisting of arylalcohols, lactams, oximes, bisulfite and triazoles.

16. Fluorochemical composition according to claim 14 wherein said optional one or more co-reactants comprises a non-fluorinated organic compound other than said blocking agent and having one or more isocyanate reactive groups.

17. Fluorochemical composition according to claim 14 wherein said co-reactant comprises a monofunctional non-fluorinated organic compound other than said blocking agent.

18. Fluorochemical composition according to claim 14 wherein said co-reactant comprises a non-fluorinated organic compound other than said blocking agent and having polyoxyalkylene group.

19. Fluorochemical composition according to claim 1 wherein the weight ratio of the total amount of said extender to the total amount of said fluorinated polyether compound is between 5:95 and 95:5.

20. Fluorochemical composition according to claim 1 wherein said fluorinated polyether compound is dispersed or dissolved in a solvent.

21. Fluorochemical composition according to claim 1 wherein said fluorinated polyether compound is dispersed in water and wherein said fluorochemical composition comprises a surfactant.

22. Method of treatment of a fibrous substrate, comprising the step of applying to said fibrous substrate a fluorochemical composition as defined in claim 1.

23. Compound corresponding to the general formula:
R_{f}¹—[CF(CF₃)—CF₂O]ₙ—CF(CF₃)-A-Q¹-Tₖ
wherein R_{f}¹ represents a perfluorinated alkyl group, n is an integer of 3 to 25, A is a carbonyl group or a CH₂ group, Q¹ is an organic trivalent linking group, k is 2 and T represents an isocyanate reactive group and each T may be the same or different.

24. Compound according to claim 23 wherein n is an integer of 3 to 15.

25. A mixture of fluorinated polyether compounds, said mixture of fluorinated polyether compounds comprising compounds as defined in claim 23 and said mixture being free of fluorinated polyether compounds having a perfluorinated polyether moiety having a molecular weight of less than 750 g/mol or containing said fluorinated polyether compounds having a perfluorinated polyether moiety having a molecular weight of less than 750 g/mol in an amount of not more than 10% by weight relative to total weight of fluorinated polyether compounds.

26. Fluorinated polyether compound obtainable by reacting (i) a compound as defined in claim 23 or a mixture of said compounds with (ii) a polyisocyanate compound having two or more isocyanate groups or a mixture of said polyisocyanate compounds and (iii) optionally one or more co-reactants.

27. Fluorinated polyether compound according to claim 26 wherein said co-reactants comprise a isocyanate blocking agent and/or a non-fluorinated organic compound other than an isocyanate blocking agent.

28. A fluorinated polyether compound obtainable by reacting a combination of reactants comprising:
a. a fluorinated polyether of the formula:
R¹_{f}—O—[CF(CF₃)—CF₂O]ₙ—CF(CF₃)-A-Q¹-Tₖ
wherein R¹_{f} represents a perfluorinated alkyl group, n is an integer of 3 to 25, A is a carbonyl group or CH₂, Q¹ is a chemical bond or an organic divalent or trivalent linking group and T represents a functional group capable of reacting with an isocyanate and k is 1 or 2;
b. a polyisocyanate compound or a mixture of polyisocyanate compounds, and
c. optionally one or more co-reactants capable of reacting with an isocyanate group.

29. A fluorinated polyether compound according to claim 28 wherein said fluorinated polyether corresponds to the formula:
R¹_{f}—O—[CF(CF₃)—CF₂O]ₙ—CF(CF₃)—CO—X—R(OH)ₖ
wherein R¹_{f} represents a perfluorinated alkyl group, n is an integer of 3 to 25, X represents O or N, R represents an alkylene group having 1 to 8 carbon atoms and k is 1 or 2.

30. A fluorinated polyether compound that corresponds to the following formula:
(PFE)ᵤ—W—(PFA)_{w}
wherein PFE represents a perfluorinated polyether group, W represents a divalent or multivalent non-fluorinated organic linking group, PFA represents a perfluorinated aliphatic group having 3 to 18 carbon atoms, u and w each are at least 1.

31. A fluorinated polyether compound according to claim 30, wherein said perfluorinated aliphatic group PFA has from 3 to 6 carbon atoms.

32. A fluorinated polyether compound according to claim 30 wherein W comprises a polymer backbone or one or more urethane linkages.

33. A fluorochemical composition comprising a fluorinated polyether compound as defined in claim 30 and optionally comprising an extender that comprises a non-fluorinated organic compound comprising one or more blocked isocyanate groups and/or a carbodiimide compound.
